(19) United States
(12) Patent Application Publication
(10) Pub. No.: US 2012/0056931 A1
(43) Pub. Date: Mar. 8, 2012

(54) MAGENTA COLORING MATTER, INK COMPOSITION, AND COLORED BODY

(75) Inventors: Daisuke Ono, Tokyo (JP); Yutaka Ishii, Tokyo (JP); Koji Hirota, Tokyo (JP); Noriko Kajiura, Tokyo (JP)

(73) Assignee: NIPPON KAYAKU KABUSHIKI KAISHA, Tokyo (JP)

(21) Appl. No.: 13/320,651

(22) PCT Filed: Apr. 9, 2010
(86) PCT No.: PCT/JP2010/056455

§ 371 Date: Nov. 15, 2011

(30) Foreign Application Priority Data
May 18, 2009 (JP) 2009-120085

(51) Int. Cl. B41J 2/015; C09D 11/02

(52) U.S. Cl. 347/20; 106/31.47

(57) ABSTRACT

As an ink composition which is highly soluble in water and has a hue and clarity suitable for inkjet recording, an ink composition containing at least one pigment represented by formula (1) or a salt thereof as a pigment is provided. In formula (1), Xₐ to X_{c} each independently represent a substituted or unsubstituted sulfoanilino group, a substituted or unsubstituted sulfonaphthylamino group, a hydroxy group, or the like, and at least one of Xₐ to X_{c} is a group other than a hydroxy group; R represents a hydrogen atom or the like; R₁ represents an alkyl group or the like; and R₃ and R₄ each independently represent a hydrogen atom or the like.

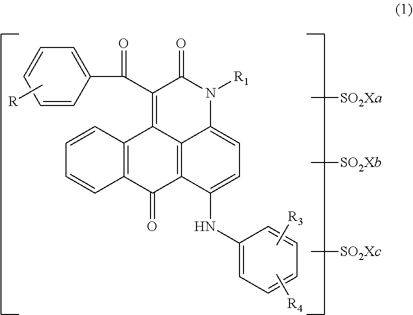

### TECHNICAL FIELD

The present invention relates to a magenta coloring matter represented by a particular formula or a salt thereof, an ink composition containing the same, a recording method carried out using the ink composition, and a colored body obtained by coloring with the ink composition.

### BACKGROUND ART

For a recording method by an ink jet printer, which is one typical method among a variety of color recording methods, i.e., ink jet recording, a variety of ink discharge systems have been developed. These systems execute recording by generating ink droplets, which are attached to any of a variety of record-receiving materials such as e.g., paper, film, and fabric, etc. According to this recording method, a printer head is not brought into direct contact with the record-receiving material; therefore, production of noise can be avoided to achieve silent recording. In addition, due to having the feature of reduced size, increased speed and coloring can be readily achieved. Thus, prevalence in recent years has been in rapid progress, and great advancement hereafter is expected.

Inks containing a water-soluble coloring matter (dye) dissolved in an aqueous medium have been used as conventional inks for fountain pens, felt pens etc., and inks for ink jet recording. Furthermore, to these inks is generally added a water-soluble organic solvent in order to prevent pen tips or ink discharge nozzles from clogging with the ink. For these inks, demanded are abilities to generate a recorded image with satisfactory density, probability of avoiding occurrence of clogging at the pen tips and nozzles, favorable drying characteristics on the record-receiving materials, suppression of bleeding, superior storage stability, and the like. Additionally, a variety of fastness such as water resistance, moisture resistance, light resistance and gas resistance has been required of the recorded image.

On the other hand, as a process for recording image or character information displayed on a color display of a computer in full color by an ink jet printer, subtractive color mixing generally with four inks having different colors, yellow (Y), magenta (M), cyan (C) and black (K) is exemplified. In order to reproduce an additive color mixing image formed with red (R), green (G), blue (B) on a CRT display and the like as accurately as possible using subtractive color mixing, it is desired that each Y, M and C are brilliant, and have a hue as approximate as possible to each standard.

Applications of ink jet printers have expanded from compact printers for OA (Office Automation) to large printers for industrial use, and accordingly a variety of fastness as described above has been desired for ink jet recording image more than ever.

Water resistance has been greatly improved by coating inorganic fine particles such as porous silica, a cationic polymer, an alumina sol or a special ceramic, capable of absorbing the coloring matter in an ink, on the surface of a record-receiving material together with a PVA resin or the like.

The moisture resistance referred to herein means resistance against a phenomenon of bleeding of a coloring matter in a record-receiving material when the record-receiving material colored is stored in a highly humid atmosphere. When bleeding of the coloring matter occurs, images with high definition of photographic image quality, in particular, have markedly deteriorated image grade; therefore, minimizing such bleeding as far as possible is important.

A technique for significantly improving light resistance has not yet been established. Many of magenta coloring matters among coloring matters of four primary colors of Y, M, C and K particularly have originally inferior light resistance. Thus, improvement of the light resistance of magenta coloring matters has been an important issue.

In addition, opportunities of recording (printing) image data with photographic image quality, which was taken by a digital camera, etc., by an ink jet printer at home have increased along with recent popularization of digital cameras and the like. Discoloration and fading of the recorded image during storing the obtained recorded matter for a long period of time owing to an oxidizing gas in the air has been also problematic. Oxidizing gases react with the coloring matter on or in the record-receiving material, causing the recorded image to become discolorated and faded. Among the oxidizing gases, ozone gas has been considered as being the main causative substance that promotes the discoloration and fading phenomenon of ink jet recording images. Since this discoloration and fading phenomenon is characteristic in ink jet recording images, improvement of the ozone gas resistance is one of the most significant problems.

Typical examples of magenta coloring matters used in aqueous inks for ink jet recording include xanthene coloring matters and azo coloring matters prepared using an H acid (1-amino-8-hydroxynaphthalene-3,6-disulfonic acid). However, xanthene coloring matters are very inferior in light resistance although they are very superior in hue and brilliance. On the other hand, some of azo coloring matters prepared using an H acid are superior in hue and water resistance, although they are inferior in light resistance, gas resistance, and brilliance. With respect to the latter, coloring matters having superior brilliance and light resistance were also developed; however, they have a still lower level of light resistance as compared with coloring matters having other hue such as cyan coloring matters typified by copper phthalocyanine coloring matters, yellow coloring matters, etc.

Although magenta coloring matters having superior brilliance and light resistance are exemplified by anthrapyridone coloring matters (for example, see Patent Documents 1 to 12), any one that satisfies all requirements of hue, brilliance, light resistance, water resistance, gas resistance, solution stability, etc., has not been obtained.

Patent Document 13 discloses a colored fine particle dispersion for ink jet, and the like, reportedly superior in light resistance of the resulting color image, and in reproducibility of the color.

Furthermore, Patent Document 14 discloses an anthrapyridone dye for use in bulk dyeing methods.

Patent Document 1: Japanese Unexamined Patent Application, Publication No. 2000-109464

Patent Document 2: Japanese Unexamined Patent Application, Publication No. H10-306221

Patent Document 3: Japanese Unexamined Patent Application, Publication No. 2000-191660

Patent Document 4: Japanese Unexamined Patent Application, Publication No. 2000-169776

Patent Document 5: Japanese Unexamined Patent Application, Publication No. 2001-72884

Patent Document 6: Japanese Unexamined Patent Application, Publication No. 2001-139836

Patent Document 7: Japanese Unexamined Patent Application, Publication No. 2002-332418

Patent Document 8: Japanese Unexamined Patent Application, Publication No. 2005-8868

Patent Document 9: Japanese Unexamined Patent Application, Publication No. 2005-314514

Patent Document 10: Japanese Unexamined Patent Application, Publication No. 2006-188706

Patent Document 11: Japanese Patent No. 3767879

Patent Document 12: PCT International Publication No. 2008/018495

Patent Document 13: Japanese Unexamined Patent Application, Publication No. 2005-126587

Patent Document 14: Japanese Unexamined Patent Application, Publication No. S50-151954

### DISCLOSURE OF THE INVENTION

### Problems to be Solved by the Invention

An object of the present invention is to provide a magenta coloring matter which has a hue suited for ink jet recording and provides recorded matter having superior ozone gas resistance, and also to provide an ink composition containing such a coloring matter.

### Means for Solving the Problems

The present inventors thoroughly investigated in order to solve the foregoing problems, and consequently found that at least one coloring matter represented by the following formula (1) or a salt thereof, and an ink composition containing the same as a coloring matter solve the aforementioned problems. Thus, the present invention was completed.

Accordingly, a first aspect of the present invention provides an ink composition containing at least one coloring matter represented by the following formula (1) or a salt thereof:

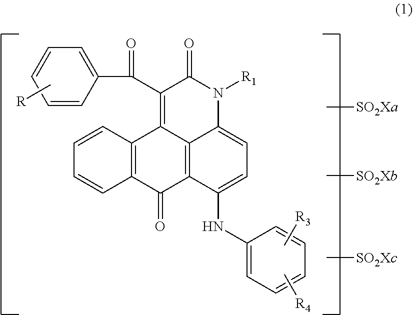

in the formula (1),

Xₐ to X_{c} each independently represent an unsubstituted sulfoanilino group; a sulfoanilino group substituted with a group selected from the group consisting of a C1-C12 alkyl group, a C1-C6 alkoxy group and a hydroxy group; an unsubstituted sulfonaphthylamino group; a sulfonaphthylamino group substituted with a C1-C4 alkyl group or a hydroxy group; or a hydroxy group;

at least one of Xₐ to X_{c} is a group other than a hydroxy group;

R represents a hydrogen atom, a carboxy group, a C1-C8 alkoxy group, a C1-C6 alkylthio group, a carbamoyl group, a cyano group, a C1-C8 alkyl group, an anilino group, a phenoxy group, an amino group, a hydroxy group, or a mercapto group;

R₁ represents a hydrogen atom, a C1-C8 alkyl group, a hydroxy C1-C4 alkyl group, a phenyl group, a mono(C1-C4 alkyl)amino C1-C4 alkyl group, a di(C1-C4 alkyl)amino C1-C4 alkyl group, or a cyano C1-C4 alkyl group; and

R₃ and R₄ each independently represent a hydrogen atom or a C1-C8 alkyl group.

A second aspect of the present invention provides the ink composition according to the first aspect, in which total content of the coloring matter contained in the ink composition is 0.5 to 20% by mass relative to the total mass of the ink composition.

A third aspect of the present invention provides the ink composition according to the first or second aspect, further containing a water-soluble organic solvent.

A fourth aspect of the present invention provides the ink composition according to any one of the first to third aspects, in which the ink composition is utilizing in ink jet recording.

A fifth aspect of the present invention provides the ink composition according to any one of the first to fourth aspects, in which the content of inorganic impurities in total mass of the coloring matter contained in the ink composition is no greater than 1% by mass relative to the total mass of the coloring matter.

A sixth aspect of the present invention provides an ink jet recording method including discharging ink droplets in response to recording signals using the ink composition according to any one of the first to fifth aspects as an ink to allow the droplets to adhere onto a record-receiving material thereby executing recording.

A seventh aspect of the present invention provides the ink jet recording method according to the sixth aspect, in which the record-receiving material is a communication sheet.

An eighth aspect of the present invention provides the ink jet recording method according to the seventh aspect, in which the communication sheet is a plain paper or a sheet having an ink receiving layer containing a porous white inorganic substance.

A ninth aspect of the present invention provides a colored body which was colored with the ink composition according to any one of the first to fifth aspects.

A tenth aspect of the present invention provides a colored body which was colored by the ink jet recording method according to the sixth aspect.

An eleventh aspect of the present invention provides an ink jet printer equipped with a vessel containing the ink composition according to any one of the first to fifth aspects.

A twelfth aspect of the present invention provides the ink composition according to the first aspect, in which the coloring matter represented by the above formula (1) or a salt thereof is a coloring matter represented by the following formula (2) or a salt thereof:

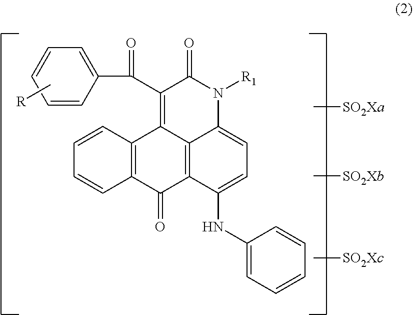

in the formula (2), Xₐ to X_{c}, R, and R₁ are as defined in the formula (1).

A thirteenth aspect of the present invention provides the ink composition according to the first aspect, in which the coloring matter represented by the above formula (1) or a salt thereof is a coloring matter represented by the following formula (3) or a salt thereof:

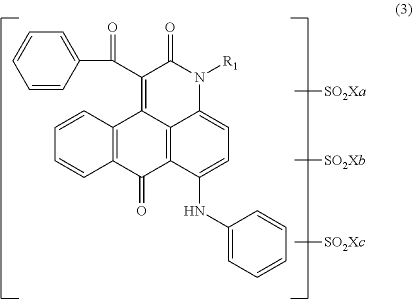

in the formula (3), Xₐ to X_{c}, and R₁ are as defined in the formula (1).

A fourteenth aspect of the present invention provides the ink composition according to the first aspect, in which the coloring matter represented by the above formula (1) or a salt thereof is a coloring matter represented by the following formula (4) or a salt thereof:

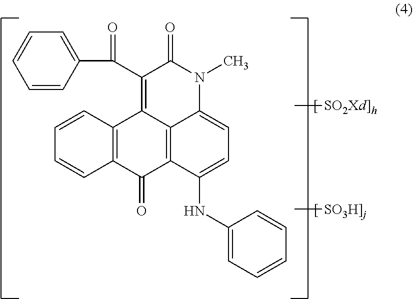

in the formula (4),

X_{d} represents an unsubstituted sulfoanilino group; a sulfoanilino group substituted with a group selected from the group consisting of a C1-C12 alkyl group, a C1-C6 alkoxy group and a hydroxy group; an unsubstituted sulfonaphthylamino group; or a sulfonaphthylamino group substituted with a C1-C4 alkyl group or a hydroxy group;

h and j are both an average value; h is from 0.8 to 3.0; j is from 0 to 2.2; and the sum of h and j is 3.0.

A fifteenth aspect of the present invention provides the ink composition according to the first aspect, in which the coloring matter represented by the above formula (1) or a salt thereof is a coloring matter or a salt thereof obtained by any one of the following synthesis method a) and synthesis method b),

### Synthesis Method a):

a method including allowing a compound represented by the following formula (5) to react with at least one amine selected from the group consisting of an unsubstituted sulfoaniline; a sulfoaniline substituted with a group selected from the group consisting of a C1-C12 alkyl group, a C1-C6 alkoxy group and a hydroxy group; an unsubstituted sulfonaphthylamine; and a sulfonaphthylamine substituted with a C1-C4 alkyl group or a hydroxy group, and

### Synthesis Method b):

a method including allowing a compound represented by the following formula (5) to react with at least one amine selected from the group consisting of an unsubstituted aniline; an aniline substituted with a group selected from the group consisting of a C1-C12 alkyl group, a C1-C6 alkoxy group and a hydroxy group; an unsubstituted naphthylamine; and a naphthylamine substituted with a C1-C4 alkyl group or a hydroxy group, and thereafter subjecting the obtained compound to sulfonation,

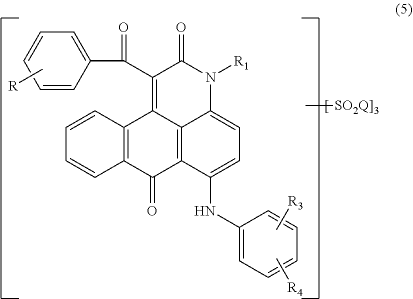

in the formula (5), Q represents a halogen atom; and R, R₁, R₃ and R₄ are as defined in the formula (1).

A sixteenth aspect of the present invention provides a magenta coloring matter consisting of at least one coloring matter represented by the following formula (1), or a salt thereof:

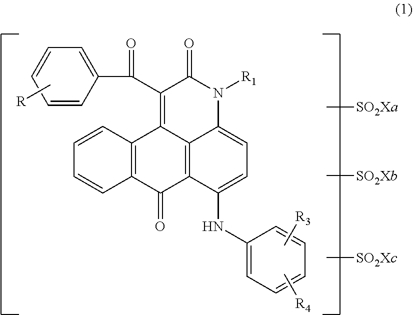

in the formula (1),

Xₐ to X_{c} each independently represent an unsubstituted sulfoanilino group; a sulfoanilino group substituted with a group selected from the group consisting of a C1-C12 alkyl group, a C1-C6 alkoxy group and a hydroxy group; an unsubstituted sulfonaphthylamino group; a sulfonaphthylamino group substituted with a C1-C4 alkyl group or a hydroxy group; or a hydroxy group; at least one of Xₐ to X_{c} is a group other than a hydroxy group;

R represents a hydrogen atom, a carboxy group, a C1-C8 alkoxy group, a C1-C6 alkylthio group, a carbamoyl group, a cyano group, a C1-C8 alkyl group, an anilino group, a phenoxy group, an amino group, a hydroxy group, or a mercapto group;

R₁ represents a hydrogen atom, a C1-C8 alkyl group, a hydroxy C1-C4 alkyl group, a phenyl group, a mono(C1-C4 alkyl)amino a C1-C4 alkyl group, a di(C1-C4 alkyl)amino C1-C4 alkyl group, or a cyano C1-C4 alkyl group; and

R₃ and R₄ each independently represent a hydrogen atom or a C1-C8 alkyl group.

A seventeenth aspect of the present invention provides the magenta coloring matter or a salt thereof according to the sixteenth aspect, in which the coloring matter represented by the above formula (1) is a coloring matter represented by the following formula (2):

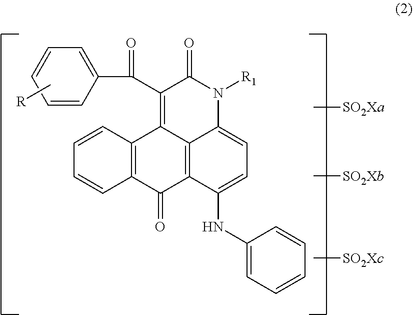

in the formula (2), Xₐ to X_{c}, R, and R₁ are as defined in the formula (1).

An eighteenth aspect of the present invention provides the magenta coloring matter or a salt thereof according to the sixteenth aspect, in which the coloring matter represented by the above formula (1) is a coloring matter represented by the following formula (3):

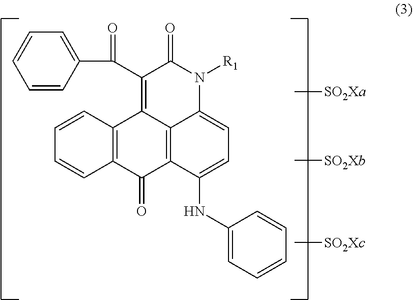

in the formula (3), Xₐ to X_{c}, and R₁ are as defined in the formula (1).

A nineteenth aspect of the present invention provides the magenta coloring matter or a salt thereof according to the sixteenth aspect, in which the coloring matter represented by the above formula (1) is a coloring matter represented by the following formula (4):

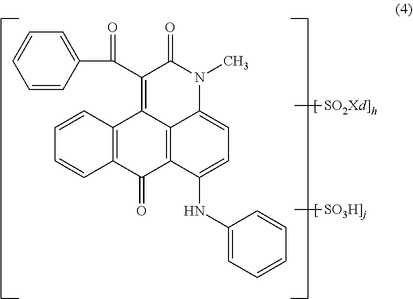

in the formula (4),

X_{d} represents an unsubstituted sulfoanilino group; a sulfoanilino group substituted with a group selected from the group consisting of a C1-C12 alkyl group, a C1-C6 alkoxy group and a hydroxy group; an unsubstituted sulfonaphthylamino group; or a sulfonaphthylamino group substituted with a C1-C4 alkyl group or a hydroxy group;

h and j are both an average value; h is from 0.8 to 3.0; j is from 0 to 2.2; and the sum of h and j is 3.0.

A twentieth aspect of the present invention provides the magenta coloring matter or a salt thereof according to the sixteenth aspect, in which the coloring matter represented by the above formula (1) is a coloring matter obtained by any one of the following synthesis method a) and synthesis method b), synthesis method a):

a method including allowing a compound represented by the following formula (5) to react with at least one amine selected from the group consisting of an unsubstituted sulfoaniline; a sulfoaniline substituted with a group selected from the group consisting of a C1-C12 alkyl group, a C1-C6 alkoxy group and a hydroxy group; an unsubstituted sulfonaphthylamine; and a sulfonaphthylamine substituted with a C1-C4 alkyl group or a hydroxy group, and synthesis method b):

a method including allowing a compound represented by the following formula (5) to react with at least one amine selected from the group consisting of an unsubstituted aniline; an aniline substituted with a group selected from the group consisting of a C1-C12 alkyl group, a C1-C6 alkoxy group and a hydroxy group; an unsubstituted naphthylamine; and a naphthylamine substituted with a C1-C4 alkyl group or a hydroxy group, and thereafter subjecting the obtained compound to sulfonation,

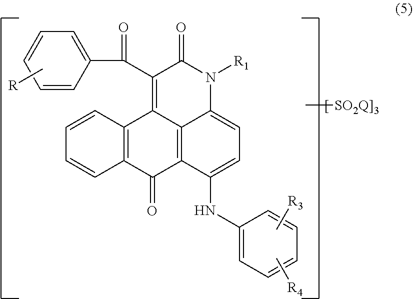

in the formula (5), Q represents a halogen atom; and R, R₁, R₃ and R₄ are as defined in the formula (1).

### Effects of the Invention

The magenta coloring matter consisting of the coloring matter represented by the above formula (1) or a salt thereof of the present invention has a characteristic feature of favorable filterability in the step of producing an ink composition on membrane filters. In addition, use of the ink composition of the present invention containing the coloring matter represented by the above formula (1) or a salt thereof as an ink, particularly as an ink for ink jet recording, enables the hue of photographic color images to be strictly reproduced on record-receiving materials. Furthermore, even if recording is carried out on a record-receiving material including inorganic fine particles coated on its surface, such as an exclusive ink jet paper (or film) for photo image quality, favorable ozone gas resistance, as well as superior long-term storage stability of such recorded image can be achieved. Therefore, the magenta coloring matter consisting of the coloring matter represented by the above formula (1) or a salt thereof of the present invention, and the ink composition of the present invention containing the coloring matter represented by the above formula (1) or a salt thereof are very useful for use in ink jet record.

### PREFERRED MODE FOR CARRYING OUT THE INVENTION

The present invention is explained in detail.

The magenta coloring matter or a salt thereof of the present invention is a magenta coloring matter consisting of at least one coloring matter represented by the above formula (1), or a salt thereof. For the sake of simplicity, both the magenta coloring matter and a salt thereof of the present invention are inclusively referred to as “the magenta coloring matter of the present invention” briefly herein below.

The ink composition of the present invention is suited as a magenta ink, particularly as a magenta ink for use in ink jet recording, and is characterized by containing at least one coloring matter represented by the above formula (1) or a salt thereof. For the sake of simplicity, both the coloring matter represented by the formula (1) and the salt thereof are inclusively referred to as “the coloring matter represented by the formula (1)” briefly herein below.

The coloring matter represented by the formula (1) may be used either as a single coloring matter, or as a mixture of a plurality of coloring matters. In light of ease and low cost in synthesis of the coloring matter, and solubility of the synthesized coloring matter, etc., the coloring matter represented by the formula (1) is preferably contained in the ink composition of the present invention as a coloring matter mixture consisting of a plurality of coloring matters.

Unless otherwise stated in particular herein, acidic functional groups such as sulfo groups and carboxy groups are represented in the form of their free acids.

The coloring matter represented by the above formula (1) is explained below.

In the above formula (1), the unsubstituted sulfoanilino group represented by Xₐ to X_{c} may have usually one to three, preferably one or two sulfo-group substitution(s), and more preferably one sulfo-group substitution.

Specific examples of the unsubstituted sulfoanilino group include those substituted with one sulfo group such as 2-sulfoanilino, 3-sulfoanilino and 4-sulfoanilino; those substituted with two sulfo groups such as 3,5-disulfoanilino; and those substituted with three sulfo groups such as 2,4,6-trisulfoanilino. Of these, 2-sulfoanilino, 3-sulfoanilino and 4-sulfoanilino are preferred, and 3-sulfoanilino and 4-sulfoanilino are more preferred.

The C1-C12 alkyl group in the sulfoanilino group substituted with a C1-C12 alkyl group represented by Xₐ to X_{c} may have a straight or branched chain, or a cyclic structure, and preferably has a straight chain. The number of carbon atoms in the alkyl group may fall within the range of usually C1-C12, preferably C1-C8, more preferably C1-C6, and still more preferably C1-C4 in the case of having a straight or branched chain; and in the case of having a cyclic structure, the number of carbon atoms is usually C3-C8, and preferably C3-C6. The number of substitution with the alkyl group is usually 1 or 2, and preferably 1.

Specific examples of the C1-C12 alkyl group include straight alkyl groups such as methyl, ethyl, n-propyl, n-butyl, n-pentyl, n-hexyl, n-heptyl, n-octyl, n-nonyl, n-decyl, n-undecyl and n-dodecyl groups; branched alkyl groups such as isopropyl, isobutyl, sec-butyl, t-butyl, isoamyl, isohexyl, isoheptyl, isooctyl, isononyl, isodecyl, isoundecyl and isododecyl groups; cyclic alkyl groups such as cyclopropyl, cyclobutyl, cyclopentyl, cyclohexyl and cycloheptyl groups; and the like. Of these, methyl is particularly preferred.

Specific examples of the sulfoanilino group substituted with a C1-C12 alkyl group represented by Xₐ to X_{c} include: those substituted with one or two straight C1-C12 alkyl group(s) such as 2-methyl-4-sulfoanilino, 2-methyl-5-sulfoanilino, 3-methyl-4-sulfoanilino, 4-methyl-2-sulfoanilino, 4-methyl-3-sulfoanilino, 3-ethyl-4-sulfoanilino, 4-ethyl-3-sulfoanilino, 4-butyl-3-sulfoanilino, 4-hexyl-3-sulfoanilino, 4-n-octyl-3-sulfoanilino, 3-dodecyl-4-sulfoanilino, 4-dodecyl-3-sulfoanilino, 3,5-dimethyl-4-sulfoanilino and 3,5-diethyl-4-sulfoanilino; those substituted with a branched C1-C12 alkyl group such as 3-isopropyl-4-sulfoanilino, 4-isopropyl-3-sulfoanilino, 3-isobutyl-4-sulfoanilino, 4-isobutyl-3-sulfoanilino and 4-tert-amyl-3-sulfoanilino; those substituted with a cyclic C1-C12 alkyl group such as 4-cyclopropyl-3-sulfoanilino, 3-cyclopentyl-4-sulfoanilino, 4-cyclopentyl-3-sulfoanilino, 3-cyclohexyl-4-sulfoanilino and 4-cyclohexyl-3-sulfoanilino; and the like. Of these, 2-methyl-4-sulfoanilino, 2-methyl-5-sulfoanilino, 3-methyl-4-sulfoanilino, 4-methyl-2-sulfoanilino and 4-methyl-3-sulfoanilino are preferred, and 4-methyl-2-sulfoanilino and 4-methyl-3-sulfoanilino are more preferred.

The C1-C6 alkoxy group in the sulfoanilino group substituted with a C1-C6 alkoxy group represented by Xₐ to X_{c} may have a straight or branched chain, and preferably has a straight chain. The range of the number of carbon atoms in the alkoxy group is usually C1 to C6, and preferably C1 to C4. The number of substitution of the alkoxy group is usually 1 or 2, and preferably 1.

Specific examples of the C1-C6 alkoxy group include those having a straight chain such as methoxy, ethoxy, n-propoxy, n-butoxy, n-pentoxy and n-hexyloxy; those having a branched chain such as isopropoxy, isobutoxy, sec-butoxy, t-butoxy, isoamyloxy and isohexyloxy; and the like. Of these, methoxy is particularly preferred.

Specific examples of the sulfoanilino group substituted with a C1-C6 alkoxy group represented by Xₐ to X_{c} include those substituted with one or two straight C1-C6 alkoxy group(s) such as 2-methoxy-5-sulfoanilino, 2-methoxy-4-sulfoanilino, 3-methoxy-4-sulfoanilino, 4-methoxy-2-sulfoanilino, 5-methoxy-2-sulfoanilino, 4-methoxy-3-sulfoanilino, 3-ethoxy-4-sulfoanilino, 3-n-propoxy-4-sulfoanilino, 4-n-butoxy-3-sulfoanilino, 4-(n-hexyloxy)-3-sulfoanilino, 3,5-dimethoxy-4-sulfoanilino and 3,5-di-n-butoxy-4-sulfoanilino; those substituted with one or two branched C1-C6 alkoxy group(s) such as 4-isopropoxy-3-sulfoanilino, 4-isobutoxy-3-sulfoanilino, 4-tert-butoxy-3-sulfoanilino and 3,5-di-tert-butoxy-4-sulfoanilino; and the like. Of these, 2-methoxy-5-sulfoanilino, 2-methoxy-4-sulfoanilino, 3-methoxy-4-sulfoanilino, 4-methoxy-2-sulfoanilino, 5-methoxy-2-sulfoanilino and 4-methoxy-3-sulfoanilino are preferred, and 2-methoxy-5-sulfoanilino and 2-methoxy-4-sulfoanilino are more preferred.

The sulfoanilino group substituted with a hydroxy group represented by Xₐ to X_{c} is exemplified by those substituted with usually 1 or 2 hydroxy group(s), and preferably 1 hydroxy group. Specific examples of the sulfoanilino group substituted with a hydroxy group include 2-hydroxy-5-sulfoanilino, 3-hydroxy-4-sulfoanilino, and the like. Of these, the former, 2-hydroxy-5-sulfoanilino, is preferred.

The unsubstituted sulfonaphthylamino group represented by Xₐ to X_{c} is exemplified by 1- or 2-naphthylamino groups having usually 1 to 3 sulfo group(s), preferably 1 or 2 sulfo group(s), and preferably 1 sulfo group. Specific examples of the unsubstituted sulfonaphthylamino group include those having 1 sulfo group such as 4-sulfo-1-naphthylamino, 5-sulfo-1-naphthylamino, 6-sulfo-1-naphthylamino, 7-sulfo-1-naphthylamino and 6-sulfo-2-naphthylamino; those having 2 sulfo groups such as 6,8-disulfo-2-naphthylamino, 5,7-disulfo-2-naphthylamino, 4,8-disulfo-1-naphthylamino and 4,8-disulfo-2-naphthylamino; those having 3 sulfo groups such as 3,6,8-trisulfo-1-naphthylamino; and the like. Of these, 4-sulfo-1-naphthylamino, 5-sulfo-1-naphthylamino, 6-sulfo-1-naphthylamino, 7-sulfo-1-naphthylamino, 6-sulfo-2-naphthylamino, and 4,8-disulfo-2-naphthylamino are preferred, and 4-sulfo-1-naphthylamino, 6-sulfo-1-naphthylamino, 6-sulfo-2-naphthylamino and 4,8-disulfo-2-naphthylamino are more preferred, and 4-sulfo-1-naphthylamino, 6-sulfo-1-naphthylamino and 6-sulfo-2-naphthylamino are still more preferred.

The C1-C4 alkyl group in the sulfonaphthylamino group substituted with a C1-C4 alkyl group represented by Xₐ to X_{c} may include those exemplified in connection with the “C1-C12 alkyl group in the sulfoanilino group substituted with a C1-C12 alkyl group represented by Xₐ to X_{c}” including preferable options, etc., except that the range of the number of carbon atoms is limited to C1-C4.

Specific examples of the sulfonaphthylamino group substituted with a C1-C4 alkyl group represented by Xₐ to X_{c} include 2-methyl-1-naphthylamino, and the like.

The sulfonaphthylamino group substituted with a hydroxy group represented by Xₐ to X_{c} is exemplified by mono or disulfonaphthylamino groups substituted with usually 1 or 2 hydroxy group(s), and preferably 1 hydroxy group. Specific examples of the sulfonaphthylamino group substituted with a hydroxy group include (mono)sulfonaphthylamino groups substituted with one hydroxy group such as 5-hydroxy-7-sulfo-1-naphthylamino, 2-hydroxy-4-sulfo-1-naphthylamino, 8-hydroxy-6-sulfo-2-naphthylamino, 5-hydroxy-8-sulfo-2-naphthylamino and 8-hydroxy-4-sulfo-1-naphthylamino; disulfonaphthylamino groups substituted with one hydroxy group such as 8-hydroxy-4,6-disulfo-1-naphthylamino and 8-hydroxy-2,4-disulfo-1-naphthylamino; and the like. Of these, 5-hydroxy-7-sulfo-1-naphthylamino and 8-hydroxy-2,4-disulfo-1-naphthylamino are preferred.

Xₐ to X_{c} preferably represent among the foregoings, an unsubstituted sulfoanilino group; a sulfoanilino group substituted with a C1-C12 alkyl group; a sulfoanilino group substituted with a C1-C6 alkoxy group; a sulfonaphthylamino group; or a hydroxy group. It should be noted that at least one of Xₐ to X_{c} is a group other than a hydroxy group.

In the above formula (1), exemplary C1-C8 alkoxy group represented by R may have a straight or branched chain, and preferably has a straight chain. With respect to the range of the number of carbon atoms, usually C1-C8, preferably C1-C6, and more preferably C1-C4 are exemplified.

Specific examples include those having a straight chain such as methoxy, ethoxy, n-propoxy, n-butoxy, n-pentoxy, n-hexyloxy, n-heptyloxy and n-octyloxy; those having a branched chain such as isopropoxy, isobutoxy, sec-butoxy and t-butoxy; and the like.

The C1-C6 alkylthio group represented by R may have a straight or branched chain, and preferably has a straight chain. The range of the number of carbon atoms is usually C1-C6, and preferably C1-C4.

Specific examples of the C1-C6 alkylthio group include those having a straight chain such as methylthio, ethylthio, n-propylthio, n-butylthio, n-pentylthio and n-hexylthio; those having a branched chain such as isopropylthio, isobutylthio, sec-butylthio and t-butylthio; and the like.

The C1-C8 alkyl group represented by R may include those exemplified in connection with the “C1-C12 alkyl group in the sulfoanilino group substituted with a C1-C12 alkyl group represented by Xₐ to X_{c}” including preferable options, etc., except that the range of the number of carbon atoms is limited to C1-C8. Also, the number of carbon atoms may fall within the range of usually C1-C8, preferably C1-C6, and more preferably C1-C4 in the case of having a straight or branched chain; and in the case of having a cyclic structure, the number of carbon atoms is C3-C8, and preferably C3-C6.

Of the foregoing, R in the formula (1) is preferably a hydrogen atom, a C1-C8 alkoxy group, or a C1-C8 alkyl group, more preferably a hydrogen atom, a C1-C4 alkoxy group, or a C1-C4 alkyl group, and still more preferably a hydrogen atom.

The C1-C8 alkyl group represented by R₁ in the above formula (1) may have a straight or branched chain, or a cyclic structure, and preferably has a straight chain or a cyclic structure. The range of the number of carbon atoms of the alkyl group may fall within the range of usually C1-C8, preferably C1-C6, and more preferably C1-C4 in the case of having a straight or branched chain; and in the case of having a cyclic structure, the number of carbon atoms is usually C3-C8, preferably C3-C6.

Specific examples of the C1-C8 alkyl group include those having a straight chain such as methyl, ethyl, n-propyl, n-butyl, n-pentyl, n-hexyl, n-heptyl and n-octyl; those having a branched chain such as isopropyl, isobutyl, sec-butyl, t-butyl, isoamyl, isohexyl, isoheptyl and isooctyl; those having a cyclic structure such as cyclopropyl, cyclobutyl, cyclopentyl, cyclohexyl and cycloheptyl; and the like. Of these, methyl or cyclohexyl is preferred, and methyl is particularly preferred.

The hydroxy(C1-C4 alkyl) group represented by R₁ is exemplified by hydroxymethyl, 2-hydroxyethyl, 3-hydroxypropyl, 4-hydroxybutyl, and the like.

The mono(C1-C4 alkyl)amino C1-C4 alkyl group represented by R₁ is exemplified by monomethylamino methyl, 2-(monomethylamino)ethyl, 2-(monoethylamino)ethyl, and the like.

The di(C1-C4 alkyl)amino C1-C4 alkyl group represented by R₁ is exemplified by dimethylaminomethyl, 2-dimethylaminoethyl, 2-diethylaminoethyl, and the like.

The cyano C1-C4 alkyl group represented by R₁ is exemplified by cyanomethyl, 2-cyanoethyl, 3-cyanopropyl, 4-cyanobutyl, and the like.

The R₁ is, among the above-described ones, preferably a hydrogen atom or a C1-C8 alkyl group, and more preferably a C1-C8 alkyl group.

In the above formula (1), the C1-C8 alkyl group represented by R₃ and R₄ may include those exemplified in connection with the “C1-C12 alkyl group in the sulfoanilino group substituted with a C1-C12 alkyl group represented by Xₐ to X_{c}” including preferable options, etc., except that the range of the number of carbon atoms is limited to C1-C8. Also, the number of carbon atoms may fall within the range of usually C1-C8, preferably C1-C6, and more preferably C1-C4 in the case of having a straight or branched chain; and in the case of having a cyclic structure, the number of carbon atoms is C3-C8, and preferably C3-C6.

It is preferred that both R₃ and R are a hydrogen atom.

Although the positions of substitution with the “—SO₂Xₐ” group to the “—SO₂X_{c}” group, R, R₁, R₃, and R₄ in the above formula (1) are not particularly limited, the following positions are preferred with respect to the positions of substitution shown in the following formula (101).

### Combination (1):

Combination in which the “—SO₂Xₐ” group to the “—SO₂X_{c}” group are each situated at an arbitrary position selected from position 2′, position 6′ and position 8′ one by one; R is situated at position 3′; and R₃ and R₄ are each situated at any of two positions selected from position 7′, position 9′ and position 10′ one by one.

### Combination (2):

Combination in which the “—SO₂Xₐ” group to “—SO₂X_{c}” group are each situated at an arbitrary position selected from position 4′, position 6′ and position 8′ one by one; R is situated at position 1′; and R₃ and R₄ are each situated at any of two positions selected from position 7′, position 9′ and position 10′ one by one.

### Combination (3):

Combination in which one of the “—SO₂Xₐ” group to “—SO₂X_{c}” group is situated at position 2′, and the remaining two are each situated at any of two positions selected from position 6′, position 8′ and position 10′ one by one; R is situated at position 3′; and R₃ and R₄ are each situated at position 7′ and position 9′ one by one.

### Combination (4):

Combination in which one of the “—SO₂Xₐ” group to the “—SO₂X_{c}” group is situated at position 2′, and the remaining two are each situated at any of two positions selected from position 7′, position 8′ and position 10′ one by one; R is situated at position 3′; R₃ and R₄ are each situated at position 6′ and position 9′ one by one.

Of these combinations, Combination (1) is particularly preferred.

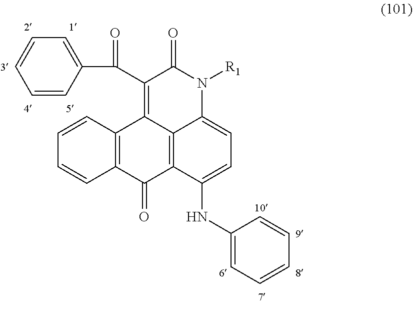

Specific examples of the coloring matter represented by the above formula (1) are shown in Table 1 below, but the coloring matter is not particularly limited thereto. In Table 1, positions of substitution with R, R₃, and R₄ correspond to the positions shown in the above formula (101). Although the positions of substitution with the “—SO₂Xₐ” group to the “—SO₂X_{c}” group are not particularly presented, they may be substituted according to any one of the Combinations (1) to (4) of the positions of substitution depending on the positions of substitution of R₃ and R₄.

TABLE 1

| No. | Xa | Xb | Xc | R | R1 | R3 | R4 |
|---|---|---|---|---|---|---|---|
| 1 | OH | OH | 2-sulfoanilino | H | methyl | H | H |
| 2 | OH | 2-sulfoanilino | 2-sulfoanilino | H | methyl | H | H |
| 3 | 2-sulfoanilino | 2-sulfoanilino | 2-sulfoanilino | H | methyl | H | H |
| 4 | OH | OH | 3-sulfoanilino | H | methyl | H | H |
| 5 | OH | 3-sulfoanilino | 3-sulfoanilino | H | methyl | H | H |
| 6 | 3-sulfoanilino | 3-sulfoanilino | 3-sulfoanilino | H | methyl | H | H |
| 7 | OH | OH | 4-sulfoanilino | H | methyl | H | H |
| 8 | OH | 4-sulfoanilino | 4-sulfoanilino | H | methyl | H | H |
| 9 | 4-sulfoanilino | 4-sulfoanilino | 4-sulfoanilino | H | methyl | H | H |
| 10 | OH | OH | 2-methoxy-5- | H | methyl | H | H |
| | | | sulfoanilino | | | | |
| 11 | OH | 2-methoxy-5- | 2-methoxy-5- | H | methyl | H | H |
| | | sulfoanilino | sulfoanilino | | | | |
| 12 | 2-methoxy-5- | 2-methoxy-5- | 2-methoxy-5- | H | methyl | H | H |
| | sulfoanilino | sulfoanilino | sulfoanilino | | | | |
| 13 | OH | OH | 6-sulfo-2- | H | methyl | H | H |
| | | | naphthylamino | | | | |
| 14 | OH | 6-sulfo-2- | 6-sulfo-2- | H | methyl | H | H |
| | | naphthylamino | naphthylamino | | | | |
| 15 | 6-sulfo-2- | 6-sulfo-2- | 6-sulfo-2- | H | methyl | H | H |
| | naphthylamino | naphthylamino | naphthylamino | | | | |
| 16 | OH | OH | 6-sulfo-1- | H | methyl | H | H |
| | | | naphthylamino | | | | |
| 17 | OH | 6-sulfo-1- | 6-sulfo-1- | H | methyl | H | H |
| | | naphthylamino | naphthylamino | | | | |
| 18 | 6-sulfo-1- | 6-sulfo-1- | 6-sulfo-1- | H | methyl | H | H |
| | naphthylamino | naphthylamino | naphthylamino | | | | |
| 19 | OH | OH | 4-sulfo-1- | H | methyl | H | H |
| | | | naphthylamino | | | | |
| 20 | OH | 4-sulfo-1- | 4-sulfo-1- | H | methyl | H | H |
| | | naphthylamino | naphthylamino | | | | |
| 21 | 4-sulfo-1- | 4-sulfo-1- | 4-sulfo-1- | H | methyl | H | H |
| | naphthylamino | naphthylamino | naphthylamino | | | | |
| 22 | OH | OH | 4-methyl-3- | H | methyl | H | H |
| | | | sulfoanilino | | | | |
| 23 | OH | 4-methyl-3- | 4-methyl-3- | H | methyl | H | H |
| | | sulfoanilino | sulfoanilino | | | | |
| 24 | 4-methyl-3- | 4-methyl-3- | 4-methyl-3- | H | methyl | H | H |
| | sulfoanilino | sulfoanilino | sulfoanilino | | | | |
| 25 | OH | OH | 6,8-disulfo-2- | H | methyl | H | H |
| | | | naphthylamino | | | | |
| 26 | OH | 6,8-disulfo-2- | 6,8-disulfo-2- | H | methyl | H | H |
| | | naphthylamino | naphthylamino | | | | |
| 27 | 6,8-disulfo-2- | 6,8-disulfo-2- | 6,8-disulfo-2- | H | methyl | H | H |
| | naphthylamino | naphthylamino | naphthylamino | | | | |
| 28 | OH | OH | 4,8-disulfo-2- | H | methyl | H | H |
| | | | naphthylamino | | | | |
| 29 | OH | 4,8-disulfo-2- | 4,8-disulfo-2- | H | methyl | H | H |
| | | naphthylamino | naphthylamino | | | | |
| 30 | 4,8-disulfo-2- | 4,8-disulfo-2- | 4,8-disulfo-2- | H | methyl | H | H |
| | naphthylamino | naphthylamino | naphthylamino | | | | |
| 31 | OH | OH | hydroxy-5- | H | methyl | H | H |
| | | | sulfoanilino | | | | |
| 32 | OH | 2-hydroxy-5- | 2-hydroxy-5- | H | methyl | H | H |
| | | sulfoanilino | sulfoanilino | | | | |
| 33 | 2-hydroxy-5- | 2-hydroxy-5- | 2-hydroxy-5- | H | methyl | H | H |
| | sulfoanilino | sulfoanilino | sulfoanilino | | | | |
| 34 | OH | OH | 5-hydroxy-7- | H | methyl | H | H |
| | | | sulfo-1- | | | | |
| | | | naphthylamino | | | | |
| 35 | OH | 5-hydroxy-7- | 5-hydroxy-7- | H | methyl | H | H |
| | | sulfo-1- | sulfo-1- | | | | |
| | | naphthylamino | naphthylamino | | | | |
| 36 | 5-hydroxy-7- | 5-hydroxy-7- | 5-hydroxy-7- | H | methyl | H | H |
| | sulfo-1- | sulfo-1- | sulfo-1- | | | | |
| | naphthylamino | naphthylamino | naphthylamino | | | | |
| 37 | OH | OH | 8-hydroxy- | H | methyl | H | H |
| | | | 2,4-disulfo-1- | | | | |
| | | | naphthylamino | | | | |
| 38 | OH | 8-hydroxy- | 8-hydroxy- | H | methyl | H | H |
| | | 2,4-disulfo-1- | 2,4-disulfo-1- | | | | |
| | | naphthylamino | naphthylamino | | | | |
| 39 | 8-hydroxy- | 8-hydroxy- | 8-hydroxy- | H | methyl | H | H |
| | 2,4-disulfo-1- | 2,4-disulfo-1- | 2,4-disulfo-1- | | | | |
| | naphthylamino | naphthylamino | naphthylamino | | | | |
| 40 | OH | OH | 3-sulfoanilino | 3′- | methyl | H | H |
| | | | | methoxy | | | |
| 41 | OH | 3-sulfoanilino | 3-sulfoanilino | 3′- | methyl | H | H |
| | | | | methoxy | | | |
| 42 | 3-sulfoanilino | 3-sulfoanilino | 3-sulfoanilino | 3′- | methyl | H | H |
| | | | | methoxy | | | |
| 43 | OH | OH | 4-sulfoanilino | 3′- | methyl | H | H |
| | | | | methoxy | | | |
| 44 | OH | 4-sulfoanilino | 4-sulfoanilino | 3′- | methyl | H | H |
| | | | | methoxy | | | |
| 45 | 4-sulfoanilino | 4-sulfoanilino | 4-sulfoanilino | 3′- | methyl | H | H |
| | | | | methoxy | | | |
| 46 | OH | OH | 2-methoxy-5- | 3′- | methyl | H | H |
| | | | sulfoanilino | methoxy | | | |
| 47 | OH | 2-methoxy-5- | 2-methoxy-5- | 3′- | methyl | H | H |
| | | sulfoanilino | sulfoanilino | methoxy | | | |
| 48 | 2-methoxy-5- | 2-methoxy-5- | 2-methoxy-5- | 3′- | methyl | H | H |
| | sulfoanilino | sulfoanilino | sulfoanilino | methoxy | | | |
| 49 | OH | OH | 6-sulfo-2- | 3′- | methyl | H | H |
| | | | naphthylamino | methoxy | | | |
| 50 | OH | 6-sulfo-2- | 6-sulfo-2- | 3′- | methyl | H | H |
| | | naphthylamino | naphthylamino | methoxy | | | |
| 51 | 6-sulfo-2- | 6-sulfo-2- | 6-sulfo-2- | 3′- | methyl | H | H |
| | naphthylamino | naphthylamino | naphthylamino | methoxy | | | |
| 52 | OH | OH | 6-sulfo-1- | 3′- | methyl | H | H |
| | | | naphthylamino | methoxy | | | |
| 53 | OH | 6-sulfo-1- | 6-sulfo-1- | 3′- | methyl | H | H |
| | | naphthylamino | naphthylamino | methoxy | | | |
| 54 | 6-sulfo-1- | 6-sulfo-1- | 6-sulfo-1- | 3′- | methyl | H | H |
| | naphthylamino | naphthylamino | naphthylamino | methoxy | | | |
| 55 | OH | OH | 3-sulfoanilino | 1′- | methyl | H | H |
| | | | | methyl | | | |
| 56 | OH | 3-sulfoanilino | 3-sulfoanilino | 1′- | methyl | H | H |
| | | | | methyl | | | |
| 57 | 3-sulfoanilino | 3-sulfoanilino | 3-sulfoanilino | 1′- | methyl | H | H |
| | | | | methyl | | | |
| 58 | OH | OH | 4-sulfoanilino | 1′- | methyl | H | H |
| | | | | methyl | | | |
| 59 | OH | 4-sulfoanilino | 4-sulfoanilino | 1′- | methyl | H | H |
| | | | | methyl | | | |
| 60 | 4-sulfoanilino | 4-sulfoanilino | 4-sulfoanilino | 1′- | methyl | H | H |
| | | | | methyl | | | |
| 61 | OH | OH | 2-methoxy-5- | 1′- | methyl | H | H |
| | | | sulfoanilino | methyl | | | |
| 62 | OH | 2-methoxy-5- | 2-methoxy-5- | 1′- | methyl | H | H |
| | | sulfoanilino | sulfoanilino | methyl | | | |
| 63 | 2-methoxy-5- | 2-methoxy-5- | 2-methoxy-5- | 1′- | methyl | H | H |
| | sulfoanilino | sulfoanilino | sulfoanilino | methyl | | | |
| 64 | OH | OH | 6-sulfo-2- | 1′- | methyl | H | H |
| | | | naphthylamino | methyl | | | |
| 65 | OH | 6-sulfo-2- | 6-sulfo-2- | 1′- | methyl | H | H |
| | | naphthylamino | naphthylamino | methyl | | | |
| 66 | 6-sulfo-2- | 6-sulfo-2- | 6-sulfo-2- | 1′- | methyl | H | H |
| | naphthylamino | naphthylamino | naphthylamino | methyl | | | |
| 67 | OH | OH | 6-sulfo-1- | 1′- | methyl | H | H |
| | | | naphthylamino | methyl | | | |
| 68 | OH | 6-sulfo-1- | 6-sulfo-1- | 1′- | methyl | H | H |
| | | naphthylamino | naphthylamino | methyl | | | |
| 69 | 6-sulfo-1- | 6-sulfo-1- | 6-sulfo-1- | 1′- | methyl | H | H |
| | naphthylamino | naphthylamino | naphthylamino | methyl | | | |
| 70 | OH | OH | 3-sulfoanilino | H | methyl | H | 7′-methyl |
| 71 | OH | 3-sulfoanilino | 3-sulfoanilino | H | methyl | H | 7′-methyl |
| 72 | 3-sulfoanilino | 3-sulfoanilino | 3-sulfoanilino | H | methyl | H | 7′-methyl |
| 73 | OH | OH | 2-methoxy-5- | H | methyl | H | 7′-methyl |
| | | | sulfoanilino | | | | |
| 74 | OH | 2-methoxy-5- | 2-methoxy-5- | H | methyl | H | 7′-methyl |
| | | sulfoanilino | sulfoanilino | | | | |
| 75 | 2-methoxy-5- | 2-methoxy-5- | 2-methoxy-5- | H | methyl | H | 7′-methyl |
| | sulfoanilino | sulfoanilino | sulfoanilino | | | | |
| 76 | OH | OH | 6-sulfo-2- | H | methyl | H | 7′-methyl |
| | | | naphthylamino | | | | |
| 77 | OH | 6-sulfo-2- | 6-sulfo-2- | H | methyl | H | 7′-methyl |
| | | naphthylamino | naphthylamino | | | | |
| 78 | 6-sulfo-2- | 6-sulfo-2- | 6-sulfo-2- | H | methyl | H | 7′-methyl |
| | naphthylamino | naphthylamino | naphthylamino | | | | |
| 79 | OH | OH | 3-sulfoanilino | H | methyl | H | 7′-ethyl |
| 80 | OH | 3-sulfoanilino | 3-sulfoanilino | H | methyl | H | 7′-ethyl |
| 81 | 3-sulfoanilino | 3-sulfoanilino | 3-sulfoanilino | H | methyl | H | 7′-ethyl |
| 82 | OH | OH | 2-methoxy-5- | H | methyl | H | 7′-ethyl |
| | | | sulfoanilino | | | | |
| 83 | OH | 2-methoxy-5- | 2-methoxy-5- | H | methyl | H | 7′-ethyl |
| | | sulfoanilino | sulfoanilino | | | | |
| 84 | 2-methoxy-5- | 2-methoxy-5- | 2-methoxy-5- | H | methyl | H | 7′-ethyl |
| | sulfoanilino | sulfoanilino | sulfoanilino | | | | |
| 85 | OH | OH | 6-sulfo-2- | H | methyl | H | 7′-ethyl |
| | | | naphthylamino | | | | |
| 86 | OH | 6-sulfo-2- | 6-sulfo-2- | H | methyl | H | 7′-ethyl |
| | | naphthylamino | naphthylamino | | | | |
| 87 | 6-sulfo-2- | 6-sulfo-2- | 6-sulfo-2- | H | methyl | H | 7′-ethyl |
| | naphthylamino | naphthylamino | naphthylamino | | | | |
| 88 | OH | OH | 3-sulfoanilino | H | methyl | 6′-methyl | 9′-methyl |
| 89 | OH | 3-sulfoanilino | 3-sulfoanilino | H | methyl | 6′-methyl | 9′-methyl |
| 90 | 3-sulfoanilino | 3-sulfoanilino | 3-sulfoanilino | H | methyl | 6′-methyl | 9′-methyl |
| 91 | OH | OH | 2-methoxy-5- | H | methyl | 6′-methyl | 9′-methyl |
| | | | sulfoanilino | | | | |
| 92 | OH | 2-methoxy-5- | 2-methoxy-5- | H | methyl | 6′-methyl | 9′-methyl |
| | | sulfoanilino | sulfoanilino | | | | |
| 93 | 2-methoxy-5- | 2-methoxy-5- | 2-methoxy-5- | H | methyl | 6′-methyl | 9′-methyl |
| | sulfoanilino | sulfoanilino | sulfoanilino | | | | |
| 94 | OH | OH | 6-sulfo-2- | H | methyl | 6′-methyl | 9′-methyl |
| | | | naphthylamino | | | | |
| 95 | OH | 6-sulfo-2- | 6-sulfo-2- | H | methyl | 6′-methyl | 9′-methyl |
| | | naphthylamino | naphthylamino | | | | |
| 96 | 6-sulfo-2- | 6-sulfo-2- | 6-sulfo-2- | H | methyl | 6′-methyl | 9′-methyl |
| | naphthylamino | naphthylamino | naphthylamino | | | | |
| 97 | OH | OH | 2-sulfoanilino | H | H | H | H |
| 98 | OH | 2-sulfoanilino | 2-sulfoanilino | H | H | H | H |
| 99 | 2-sulfoanilino | 2-sulfoanilino | 2-sulfoanilino | H | H | H | H |
| 100 | OH | OH | 3-sulfoanilino | H | H | H | H |
| 101 | OH | 3-sulfoanilino | 3-sulfoanilino | H | H | H | H |
| 102 | 3-sulfoanilino | 3-sulfoanilino | 3-sulfoanilino | H | H | H | H |
| 103 | OH | OH | 4-sulfoanilino | H | H | H | H |
| 104 | OH | 4-sulfoanilino | 4-sulfoanilino | H | H | H | H |
| 105 | 4-sulfoanilino | 4-sulfoanilino | 4-sulfoanilino | H | H | H | H |
| 106 | OH | OH | 2-methoxy-5- | H | H | H | H |
| | | | sulfoanilino | | | | |
| 107 | OH | 2-methoxy-5- | 2-methoxy-5- | H | H | H | H |
| | | sulfoanilino | sulfoanilino | | | | |
| 108 | 2-methoxy-5- | 2-methoxy-5- | 2-methoxy-5- | H | H | H | H |
| | sulfoanilino | sulfoanilino | sulfoanilino | | | | |
| 109 | OH | OH | 6-sulfo-2- | H | H | H | H |
| | | | naphthylamino | | | | |
| 110 | OH | 6-sulfo-2- | 6-sulfo-2- | H | H | H | H |
| | | naphthylamino | naphthylamino | | | | |
| 111 | 6-sulfo-2- | 6-sulfo-2- | 6-sulfo-2- | H | H | H | H |
| | naphthylamino | naphthylamino | naphthylamino | | | | |
| 112 | OH | OH | 6-sulfo-1- | H | H | H | H |
| | | | naphthylamino | | | | |
| 113 | OH | 6-sulfo-1- | 6-sulfo-1- | H | H | H | H |
| | | naphthylamino | naphthylamino | | | | |
| 114 | 6-sulfo-1- | 6-sulfo-1- | 6-sulfo-1- | H | H | H | H |
| | naphthylamino | naphthylamino | naphthylamino | | | | |
| 115 | OH | OH | 4-sulfo-1- | H | H | H | H |
| | | | naphthylamino | | | | |
| 116 | OH | 4-sulfo-1- | 4-sulfo-1- | H | H | H | H |
| | | naphthylamino | naphthylamino | | | | |
| 117 | 4-sulfo-1- | 4-sulfo-1- | 4-sulfo-1- | H | H | H | H |
| | naphthylamino | naphthylamino | naphthylamino | | | | |

The coloring matter represented by the above formula (1) is preferably a coloring matter represented by the above formula (2), and more preferably a coloring matter represented by the above formula (3).

In the above formulae (2) and (3) , Xₐ to X_{c}, R, and R₁ which may be optionally selected are as defined in connection with the above formula (1) including preferable options, etc.

The positions of substitution of the “—SO₂Xₐ” group to the “—SO₂X_{c}” group, and R in the formula (2) may be similar to Combinations (1) to (4) of the positions of substitution as defined in connection with the above formula (1) including preferable options, in which R₃ and R₄ in the above formula (1) are regarded as a hydrogen atom.

Also, the “—SO₂Xₐ” group to the “—SO₂X_{c}” group in the formula (3) are preferably each substituted at an arbitrary position selected from position 2′, position 6′ and position 8′ one by one in the above formula (101).

The coloring matter represented by the above formulae (1) to (3) is particularly preferably a coloring matter represented by the above formula (4).

The coloring matter represented by the formula (4) includes, among the coloring matters represented by the above formulae (1) to (3), mixtures of coloring matters represented by the above formulae (1) to (3) in which at least one of Xₐ to X_{c} is a group other than a hydroxy group, and the group other than a hydroxy group is a single group selected from the group consisting of an unsubstituted sulfoanilino group; a sulfoanilino group substituted with a group selected from the group consisting of a C1-C12 alkyl group, a C1-C6 alkoxy group, and a hydroxy group; an unsubstituted sulfonaphthylamino group; and a sulfonaphthylamino group substituted with a C1-C4 alkyl group or a hydroxy group.

Exemplary coloring matter represented by the formula (4) includes mixtures of at least three kinds of coloring matters in which all Xₐ to X_{c} are an unsubstituted sulfoanilino group; at least two of Xₐ to X_{c} are an unsubstituted sulfoanilino group, and the remaining one is a hydroxy group; and any one of Xₐ to X_{c} is an unsubstituted sulfoanilino group, and the remaining two are a hydroxy group.

Therefore, in the formula (4), the unsubstituted sulfoanilino group; the sulfoanilino group substituted with a group selected from the group consisting of a C1-C12 alkyl group, a C1-C6 alkoxy group, and a hydroxy group; the unsubstituted sulfonaphthylamino group; and the sulfonaphthylamino group substituted with a C1-C4 alkyl group or a hydroxy group, which are represented by X_{d} are as defined in connection with the groups represented by Xₐ to X_{c} in the above formula (1) including preferable options, etc.

In the formula (4), h and j are an average value indicating the number of substitution with the “—SO₂X_{d}” group and the “—SO₃H” group (sulfo group), respectively, and the sum of h and j is 3.0.

Here, h is usually from 0.8 to 3.0, and preferably from 1.0 to 3.0.

Also, j is usually from 0 to 2.2, and preferably from 0 to 2.0. The coloring matter represented by the formula (4) is substantially a mixture of coloring matters having a certain anthrapyridone structure substituted with three in total of a “—SO₂X_{d}” group and a “—SO₃H” group. Therefore, values of h and j in the formula (4) may be calculated by carrying out HPLC analysis of the coloring matter mixture, and measuring the area ratio on the HPLC of each single coloring matter constituting the coloring matter mixture. By way of an example, a method of calculating h in a coloring matter mixture (A) having the following constitution shown in Table 2 below. It should be noted that the “HPLC area ratio” is a value derived when the total area corresponding to the intended coloring matters represented by the formula (4) is assumed to be 100%.

TABLE 2
Example of results of HPLC analysis
of coloring matter mixture (A)

| Number of substitution with | |
|---|---|
| “—SO₂Xd” group | HPLC area ratio (%) |
| 1 | A₁ |
| 2 | A₂ |
| 3 | A₃ |

### Method of Calculating Average Value h in Coloring Matter Mixture (A):

h=[(1×A₁)+(2×A₂)+(3×A₃)]/(A₁+A₂+A₃)

The area ratio on the HPLC presented herein is a value derived by rounding the calculated h to one decimal place, using the found value up to one digit after the decimal point. It is to be noted that the average value j may be calculated similarly to the aforementioned calculation method of h, but may be conveniently calculated according to the formula of “j=3.0−h”.

The number of substitution with “—SO₂X_{d}” group in the aforementioned HPLC analysis may be readily determined based on a mass derived by, for example, fractionating the peak of each single coloring matter detected on the HPLC and subjecting the fraction to an instrumental analysis such as mass spectrometry. In brief, mass spectrometry is carried out in conjunction with measurement of LC as in LC/MS, and the number of substitution may be determined from thus derived mass.

With respect to positions of substitution with the “—SO₂X_{d}” group and the “—SO₃H” group in the above formula (4), it is preferred that these groups are substituted one by one at an arbitrary position selected from position 2′, position 6′, and position 8′ in the above formula (101).

The coloring matter represented by the formula (4) is a mixture of isomeric coloring matters which are different in terms of substitution ratio, and position of substitution of the “—SO₂X_{d}” group and the “—SO₃H” group. Of these, in connection with the substitution ratio, examples may include: three “—SO₂X_{d}” groups and no “—SO₃H” group; two “—SO₂X_{d}” groups and one “—SO₃H” group; one “—SO₂X_{d}” group and two “—SO₃H” groups; and the like. Also, in regard to the position of substitution, provided that two “—SO₂X_{d}” groups and one “—SO₃H” group are included, examples include: the “—SO₂X_{d}” group being situated at position 2′ and position 6′, and the “—SO₃H” group being situated at position 8′; the “—SO₂X_{d}” group being situated at position 2′ and position 8′, and the “—SO₃H” group being situated at position 6′; the “—SO₂X_{d}” group being situated at position 6′ and position 8′, and the “—SO₃H” group being situated at position 2′; and the like.

In connection with Xₐ to X_{c}, R, R₁, R₃, R₄, X_{d}, h, and j optionally selected for the coloring matter each represented by the above formulae (1) to (4), combination coloring matters of preferable options are more preferred, and combination coloring matters of more preferable options are even more preferred. The same is applied to combinations of preferable options with more preferable options.

The coloring matter represented by the above formula (1) is produced by, for example the following method. In the following formulae (6) and formula (7), any of Xₐ to X_{c}, R₁, R₃, R₄, and R which may be optionally selected is as defined in connection with the above formula (1).

Specifically, a reaction is carried out with 1 mol of an anthraquinone compound represented by the following formula (6) obtained in accordance with a well-known method as disclosed in Japanese Examined Patent Application, Publication No. H7-45629 and the like, and a benzoyl acetate ester having R as a substituent in the presence of a base such as sodium carbonate, potassium carbonate, sodium acetate or potassium acetate as a catalyst at 100 to 200° C. for 3 to 30 hrs in a solvent such as orthodichlorobenzene, monochlorobenzene, nitrobenzene or xylene. After completing the reaction, the mixture is cooled, and diluted with a C1-C4 alcohol such as methanol, ethanol or propanol. Thus precipitated solid is separated by filtration, followed by washing with the C1-C4 alcohol as needed and further washing with water or warm water, and then dried to obtain a compound represented by the following formula (7).

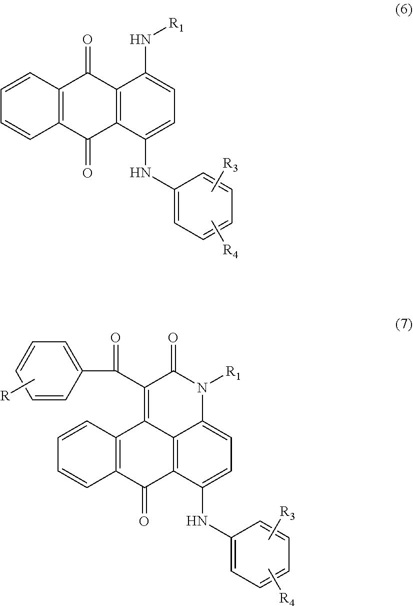

Thus obtained compound represented by the above formula (7) is subjected to chlorosulfonylation in chlorosulfonic acid at 40 to 120° C., and then at 70 to 80° C. after adding thionyl chloride to obtain a compound represented by the above formula (5).

In the formula (5), Q represents a halogen atom, preferably a chlorine atom, a bromine atom, or an iodine atom, and more preferably a chlorine atom.

Although the position of substitution of the “—SO₂Q” group in the formula (5) is not particularly limited, since three “—SO₂Q” groups correspond to three groups of from the “—SO₂Xₐ” group to the “—SO₂X_{c}” group in the formula (1), the positions of substitution of the “—SO₂Q” groups in the formula (5) are preferably those derived by regarding the “—SO₂Xₐ” group to the “—SO₂X_{c}” group in Combinations (1) to (4) in connection with the positions of substitution in the above formula (1) as “—SO₂Q” group.

A base such as sodium hydroxide is used preferably in water for adjusting the pH of a mixture of thus obtained compound represented by the formula (5), and at least one amine selected from the group consisting of: an unsubstituted sulfoaniline; a sulfoaniline substituted with a group selected from the group consisting of a C1-C12 alkyl group, a C1-C6 alkoxy group, and a hydroxy group; an unsubstituted sulfonaphthylamine; and a sulfonaphthylamine substituted with a C1-C4 alkyl group or a hydroxy group. Then the mixture is subjected to a condensation reaction with stirring, at room temperature or while cooling if necessary to obtain the coloring matter represented by the above formula (1). The synthesis method of the coloring matter represented by the formula (1) is referred to herein as synthesis method a).

The aforementioned amines correspond to Xₐ to X_{c} in the formula (1), and each represented by the general formula of “H—Xₐ”, “H—X_{b}”, and “H—X_{c}”. Therefore, the amine is preferably an unsubstituted sulfoaniline; a sulfoaniline substituted with a C1-C12 alkyl group; a sulfoaniline substituted with a C1-C6 alkoxy group; or a sulfonaphthylamine.

Also in an alternative way, the coloring matter represented by the above formula (1) may be synthesized by the following method. More specifically, a base such as sodium hydroxide is used preferably in water for adjusting the pH of a mixture of the compound represented by the above formula (5), and at least one amine selected from the group consisting of: an unsubstituted aniline; an aniline substituted with a group selected from the group consisting of a C1-C12 alkyl group, a C1-C6 alkoxy group, and a hydroxy group; an unsubstituted naphthylamine; and a naphthylamine substituted with a group selected from the group consisting of a C1-C4 alkyl group and a hydroxy group. Then the mixture is subjected to a condensation reaction with stirring, at room temperature or while cooling if necessary, and the resulting compound is sulfonated, whereby the coloring matter represented by the above formula (1) is also obtained. The synthesis method of the coloring matter represented by the formula (1) is referred to herein as synthesis method b).

The sulfonation process which may be employed in the synthesis method b) is exemplified by a process of sulfonation performed in fuming sulfuric acid at 0 to 40° C. It should be noted that depending on the reaction conditions of the sulfonation, a part of the obtained sulfamoyl group is hydrolysed due to the condensation reaction of the compound represented by the formula (5) with the aforementioned certain amine, and thus conversion to sulfonic acid may occur.

Examples of the synthesis method a) include Step 3 of Example 1, and Examples 2 to 6 in EXAMPLES described later. In addition, examples of the synthesis method b) similarly include (Step 2) in each of Example 7 and Example 8.

In the coloring matter represented by the above formula (1) contained in the ink composition of the present invention, as the ratio of a group other than a hydroxy group in Xₐ to X_{c} increases, solubility of the dye in water decreases although fastness properties of the image recorded using the ink composition are improved. The ink composition of the present invention may include those not substantially containing water; however, it is preferable to contain water, i.e., the composition is preferably a water-based ink composition.

Therefore, taking into consideration the storage stability as the water-based ink composition, and fastness properties of the recorded image, for the purpose of improving solubility in water along with setting of the ratio of the group other than a hydroxy group in Xₐ to X_{c}, it is preferred to prepare a coloring matter mixture of one or more types, preferably one to eight types, and more preferably three to seven types of the coloring matter represented by the above formula (1).

The coloring matter represented by the above formulae (1) to (4) is present in the form of either a free acid or a salt thereof. The salt of the compound represented by the above formula (1) may be a salt with an inorganic or organic cation. Specific examples of the inorganic cation salt include: ammonium salts; alkali metal salt, for example, salts with lithium, sodium, potassium or the like; and the like. Examples of the organic cation salt include quaternary ammonium salts represented by the following formula (8), but not limited thereto.

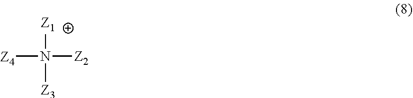

In the above formula (8), Z₁ to Z₄ each independently represent a hydrogen atom, a C1-C4 alkyl group, a hydroxy C1-C4 alkyl group, or a hydroxy(C1-C4)alkoxy(C1-C4)alkyl group, and at least one of Z₁ to Z₄ is a group other than a hydrogen atom.

In the above formula (8), examples of the C1-C4 alkyl group represented by Z₁ to Z₄ include methyl, ethyl, and the like.

Similarly, examples of the hydroxy C1-C4 alkyl group include hydroxymethyl, hydroxyethyl, 3-hydroxypropyl, 2-hydroxypropyl, 4-hydroxybutyl, 3-hydroxybutyl, 2-hydroxybutyl, and the like.

Also, examples of the hydroxy(C1-C4)alkoxy(C1-C4)alkyl group similarly include hydroxyethoxymethyl, 2-hydroxyethoxyethyl, 3-(hydroxyethoxy)propyl, 3-(hydroxyethoxy)butyl, 2-(hydroxyethoxy)butyl, and the like.

Among the aforementioned salts, preferable salts include sodium, potassium, lithium, monoethanolamine, diethanolamine, triethanolamine, monoisopropanolamine, diisopropanolamine and triisopropanolamine salts, ammonium salts, and the like. Of these, particularly preferred are lithium, sodium, potassium, and ammonium salts.

As would be apparent to persons skilled in the art, salts of the coloring matter represented by the above formulae (1) to (4) can be easily obtained with the following method and the like.

For example, in an exemplary process for obtaining a sodium salt, salt precipitation is carried out by adding dietary salt to a liquid such as: a reaction liquid obtained after completing the final step of the synthesis reaction of the compound; or an aqueous solution prepared by dissolving a wet cake or a dry matter containing the compound, and then filtering the deposited solids.

Alternatively, a free acid of the compound; or a mixture of a free acid including a sodium salt of the compound in part, and the sodium salt; can be obtained after the solid of the obtained sodium salt is dissolved in water, an acid such as hydrochloric acid is added thereto to appropriately adjust the pH of the solution, followed by filtration of the deposited solids.

Moreover, each corresponding potassium salt, lithium salt, ammonium salt, or quaternary ammonium salt can be also obtained by stirring the solid of a free acid of the compound with water, and adding to this liquid, for example, potassium hydroxide, lithium hydroxide, ammonia, a hydroxide of a quaternary ammonium salt represented by the formula (8) or the like to make alkaline. Addition of a plurality of the aforementioned various types of hydroxides in a limited number of moles with respect the number of moles of the free acid in this procedure enables a mixed salt etc., of, for example, lithium and sodium, as well as a mixed salt etc., of lithium, sodium, potassium, and ammonium to be obtained.

The salt of the compound may result in change of: the physical properties such as solubility depending on the type of the salt; or when used in ink, performances, particularly fastness properties, of the ink. Therefore, the type of the salt is preferably selected to meet the intended performances and the like of the ink.

The total content the coloring matter contained in the ink composition of the present invention is usually 0.5 to 20% by mass, preferably 1 to 10% by mass, more preferably 1.5 to 6% by mass, and still more preferably 3 to 6% by mass with respect to the total mass of the ink composition.

As described later, for the purpose of finely adjusting the magenta hue, and the like, other coloring matter, e.g., a well-known coloring matter may be further included in the ink composition of the present invention, in the range not to impair the effects achievable by the present invention. However, in the coloring matter included in the ink composition of the present invention, it is preferred that all coloring matters are substantially represented by the above formula (1), and more preferably the coloring matter included in the ink composition is a mixture of the coloring matters represented by the formula (1).

The coloring matter represented by the above formula (1) contained in the ink composition of the present invention may be isolated as a solid free acid by adding a mineral acid such as hydrochloric acid after completing the synthesis reaction. By washing the solid of the obtained free acid with water or acidic water such as anhydrous hydrochloric acid, and the like, inorganic salts, e.g., a chloride of a metal cation such as sodium chloride, as well as an alkali metal salt of sulfuric acid cation such as sodium sulfate, and the like included as impurities, i.e., “inorganic impurities” as herein referred to can be removed. Alternatively, inorganic impurities can be removed also by a method including adding, for example, ammonium chloride after completing the synthesis reaction of the coloring matter represented by the formula (1) to allow the ammonium salt of the intended product to be deposited, which is then dissolved in water to prepare a solution, and thereafter adding a C1-C4 alcohol such as isopropanol thereto to again allow the intended product to be deposited. There operations may be repeated as needed to improve the purity of the intended product, or to decrease the content of the inorganic impurities.

When the ink composition of the present invention is prepared, these inorganic impurities often adversely affect storage stability of the ink composition, and discharge stability achieved in carrying out ink jet recording or the like in which the ink composition is used as an ink. Therefore, when the ink composition of the present invention is used particularly in ink jet recording, the content of the inorganic impurities in the total mass of the coloring matter included in the ink composition of the present invention is preferably no greater than 1% by mass with respect to the total mass of the coloring matter, and the lower limit may be 0% by mass, i.e., the detection limit or lower of the analytical equipment.

As a method for producing a coloring matter containing a lower amount of the inorganic impurities, a method of eliminating inorganic impurities by, for example, a reverse osmosis membrane, has been known. In other exemplary method, a dry matter or wet cake of the coloring matter is purified by suspending in C1-C4 alcohol such as methanol or isopropanol, or as needed a mixed solvent of the alcohol and water.

The ink composition of the present invention is suited for staining of natural and synthetic fiber materials or blended fabric products, and for production of various types of writing inks, particularly inks for ink jet recording.

A reaction liquid after completing the final step in the synthesis reaction of the coloring matter represented by the above formula (1), and the like can be directly used for producing the ink composition of the present invention. However, after isolating from the reaction liquid by, for example, spray drying, crystallization or the like, and drying as needed, the intended coloring matter can be used to produce an ink composition.

The ink composition of the present invention is prepared with water as a medium, and may contain a water-soluble organic solvent and an ink preparation agent as needed in the range not to deteriorate the effects of the present invention. The water-soluble organic solvent is used for the purpose of effects such as solubilizing the coloring matter, preventing drying of the composition (maintaining the wet state), adjusting the viscosity of the composition, accelerating permeation of the composition into the record-receiving materials, adjusting the surface tension of the composition, defoaming of the composition, and the like, and it is preferred that the water soluble organic solvent is contained in the ink composition of the present invention.

The ink preparation agent includes well-known additives such as, for example, a preservative and fungicide, a pH adjusting agent, a chelating reagent, a rust-preventive agent, an ultraviolet ray absorbing agent, a viscosity adjusting agent, a dye solubilizer, a discoloration-preventive agent, an emulsification stabilizer, a surface tension adjusting agent, and a defoaming agent.

The content of the water-soluble organic solvent is usually 0 to 60% by mass, and preferably 10 to 50% by mass of the total mass of the ink composition, whereas the ink preparation agent may be used in an amount of 0 to 20% by mass, and preferably 0 to 15% by mass, similarly. The remaining component is water.

Examples of the water-soluble organic solvent include: C1-C4 alcohols such as methanol, ethanol, n-propanol, isopropanol, n-butanol, isobutanol, secondary butanol and tertiary butanol; amides such as N,N-dimethyl formamide and N,N-dimethylacetamide; heterocyclic ketones such as 2-pyrrolidone, N-methyl-2-pyrrolidone, hydroxyethyl-2-pyrrolidone, 1,3-dimethylimidazolidine-2-one and 1,3-dimethylhexahydropyrimid-2-one; ketone or ketoalcohols such as acetone, methylethylketone and 2-methyl-2-hydroxypentan-4-one; cyclic ethers such as tetrahydrofuran and dioxane; mono-, oligo-, or poly-alkylene glycols or thioglycols having a C2-C6 alkylene unit such as ethylene glycol, 1,2- or 1,3-propylene glycol, 1,2- or 1,4-butylene glycol, 1,6-hexylene glycol, diethylene glycol, triethylene glycol, tetraethylene glycol, dipropylene glycol, polyethylene glycol, polypropylene glycol and thiodiglycol; polyols (triols) such as glycerin and hexane-1,2,6-triol; C1-C4 monoalkyl ethers of a polyhydric alcohol such as ethylene glycol monomethyl ether, ethylene glycol monoethyl ether, diethylene glycol monomethyl ether, diethylene glycol monoethyl ether, diethylene glycol monobutyl ether (butylcarbitol), triethylene glycol monomethyl ether and triethylene glycol monoethyl ether; γ-butyrolactone, dimethyl sulfoxide, and the like.

As the water-soluble organic solvent, preferable examples include isopropanol, glycerin, mono-, di-, or tri-ethylene glycol, dipropylene glycol, 2-pyrrolidone, N-methyl-2-pyrrolidone, and butylcarbitol, whereas more preferable examples include isopropanol, glycerin, diethylene glycol, 2-pyrrolidone, N-methyl-2-pyrrolidone, and butylcarbitol. These water soluble organic solvents may be used either alone, or as a mixture.

Examples of the preservative and fungicide include organic sulfur based, organic nitrogen sulfur based, organic halogen based, haloaryl sulfone based, iodopropargyl based, N-haloalkylthio based, benzothiazole based, nitrile based, pyridine based, 8-oxyquinoline based, isothiazoline based, dithiol based, pyridineoxide based, nitropropane based, organic tin based, phenol based, quaternary ammonium salt based, triazine based, thiadiazine based, anilide based, adamantane based, dithiocarbamate based, brominated indanone based, benzyl bromo acetate based, or inorganic salt based compounds, and the like.

The organic halogen based compound may include, for example, sodium pentachlorophenol.

The pyridineoxide based compound may include, for example, sodium 2-pyridinethiol-1-oxide.

The isothiazoline based compound may include, for example, 1,2-benzisothiazolin-3-one, 2-n-octyl-4-isothiazolin-3-one, 5-chloro-2-methyl-4-isothiazolin-3-one, 5-chloro-2-methyl-4-isothiazolin-3-one magnesium chloride, 5-chloro-2-methyl-4-isothiazolin-3-one calcium chloride, 2-methyl-4-isothiazolin-3-one calcium chloride, and the like.

The other preservative and fungicide may be sodium sorbate, sodium acetate, sodium benzoate, and the like.

Other specific examples of the preservative and fungicide include e.g., trade names Proxel® GXL (S), Proxel® XL-2 (S) manufactured by Arch Chemicals Japan, Inc., and the like. Superscript notation of “®” herein means registered trademark.

The pH adjusting agent may be used for the purpose of improving storage stability of the ink, and an arbitrary substance can be used as long as the pH of the ink can be controlled to fall within the range of 6.0 to 11.0 Examples of the pH adjusting agent include: alkanolamines such as diethanolamine and triethanolamine; hydroxides of alkali metals such as lithium hydroxide, sodium hydroxide and potassium hydroxide; ammonium hydroxide; carbonates of alkali metals such as lithium carbonate, sodium carbonate and potassium carbonate; and the like.

Examples of the chelating agent include sodium ethylenediamine tetraacetate, sodium nitrilotriacetate, sodium hydroxyethylethylenediamine triacetate, sodium diethylenetriamine pentaacetate, sodium uracil diacetate, and the like.

Examples of the rust-preventive agent include acidic sulfite, sodium thiosulfate, ammonium thioglycolate, diisopropylammonium nitrite, pentaerythritol tetranitrate, dicyclohexylammonium nitrite, and the like.

Examples of the ultraviolet ray absorbing agent include benzophenone based compounds, benzotriazole based compounds, cinnamic acid based compounds, triazine based compounds, stilbene based compounds, and the like. In addition, a fluorescent whitening agent as generally referred to, which is a compound that absorbs an ultraviolet ray to emit fluorescence, and which is typified by a benzoxazole based compound may be also used.

The viscosity adjusting agent may include in addition to a water soluble organic solvent, a water soluble polymer compound, and specific examples include polyvinyl alcohols, cellulose derivatives, polyamine, polyimine, and the like.

Examples of the dye solubilizer include urea, ε-caprolactam, ethylene carbonate, and the like. Of these, it is preferred to use urea.

The discoloration-preventive agent is used for the purpose of improving storability of the image. As the discoloration-preventive agent, a variety of organic and metal complex based discoloration-preventive agents may be used. Examples of the organic discoloration-preventive agent include hydroquinones, alkoxyphenols, dialkoxyphenols, phenols, anilines, amines, indanes, chromanes, alkoxyanilines, heterocycles and the like, whereas examples of the metal complex include nickel complexes, zinc complexes and the like.

As the surface tension adjusting agent, surfactants may be exemplified, and examples include anionic surfactants, amphoteric surfactants, cationic surfactants, nonionic surfactants, and the like.

Examples of the anionic surfactant include alkylsulfocarboxylic acid salts, α-olefinsulfonic acid salts, polyoxyethylenealkyl ether acetic acid salts, N-acylamino acid and salts thereof, N-acylmethyltaurine salts, alkylsulfate polyoxyalkyl ether sulfuric acid salts, alkylsulfate polyoxyethylenealkyl ether phosphoric acid salts, rosin acid soap, castor oil sulfate ester salts, lauryl alcohol sulfate ester salts, alkylphenolic phosphate esters, alkylated phosphate esters, alkylarylsulfonic acid salts, diethylsulfosuccinic acid salts, diethylhexylsulfosuccinic acid salts, dioctylsulfosuccinic acid salts, and the like.

Examples of the cationic surfactant include 2-vinylpyridine derivatives, poly(4-vinylpyridine) derivatives, and the like.

Examples of the amphoteric surfactant include lauryldimethylamino acetate betaine, 2-alkyl-N-carboxymethyl-N-hydroxyethylimidazolinium betaine, coconut oil fatty acid amide propyldimethylamino acetate betaine, polyoctylpolyaminoethylglycine, imidazoline derivatives, and the like.

Examples of the nonionic surfactant include: ether based surfactants such as polyoxyethylene nonylphenyl ether, polyoxyethylene octylphenyl ether, polyoxyethylene dodecyl phenyl ether, polyoxyethylene oleyl ether, polyoxyethylene lauryl ether and polyoxyethylene alkyl ether; ester based surfactants such as polyoxyethylene oleate esters, polyoxyethylene distearate esters, sorbitan laurate, sorbitan monostearate, sorbitan monooleate, sorbitan sesquioleate, polyoxyethylene monooleate and polyoxyethylene stearate; and acetylene glycol (alcohol) based surfactants such as 2,4,7,9-tetramethyl-5-decyne-4,7-diol, 3,6-dimethyl-4-octyne-3,6-diol and 3,5-dimethyl-1-hexyn-3-ol. Other specific examples include trade names Surfynol® 104, 82 and 465, Olfin® STG manufactured by Nissin Chemical Co., Ltd., and the like.

As the defoaming agent, a highly oxidized oil based compound, glycerin fatty acid ester based compound, fluorine based compound, silicone based compound may be used as needed.

These ink preparation agents may be used either alone or as a mixture. The surface tension of the ink that includes the ink composition of the present invention is usually 25 to 70 mN/m, and more preferably 25 to 60 mN/m. Similarly, the viscosity of the ink is adjusted to preferably no greater than 30 mPa·s, and more preferably no greater than 20 mPa·s.

In production of the ink composition of the present invention, the order of dissolving each component such as additives is not particularly limited. Water employed in preparing the ink composition preferably includes impurities in an amount as low as possible, and thus water such as ion exchanged water or distilled water is preferred.

Furthermore, precision filtration may be carried out to remove contaminants from the ink composition using a membrane filter or the like, as needed. In particular, when the ink is used as an ink for ink jet printers, carrying out the precision filtration is preferred. The filter used in carrying out the precision filtration has a pore size of usually 1 μm to 0.1 μm, and preferably 0.8 μm to 0.1 μm.

In some ink jet printers, two kinds of inks, i.e., a high concentration ink and a low concentration ink are loaded in one printer, for the purpose of supplying a high definition image. In this instance, an ink containing as a coloring matter the compound of the present invention at a high concentration, and an ink containing the same at a low concentration are prepared respectively, and these may be used in combination as an ink set. Alternatively, the ink composition of the present invention may be contained in either one of them.

Also, a well-known magenta coloring matter may be used in combination in the range not to deteriorate the effects achievable by the ink composition of the present invention.

In addition, the ink composition of the present invention may be used for the purpose of color conditioning of other colors, for example, of a black ink, or for preparing a red ink or a blue (or violet) ink by blending with a yellow coloring matter or a cyanogen coloring matter.

The ink jet recording method of the present invention includes: attaching a vessel filled with the ink composition of the present invention at a specified position of an ink jet printer for use as an ink; discharging ink droplets of the ink in response to recording signals to allow the droplets to adhere onto a record-receiving material thereby executing recording.

In the ink jet recording method of the present invention, each ink of yellow and cyan, as well as if necessary, green, blue (or violet), red, black and the like may be used in combination with the ink composition of the present invention. In this case, the ink of each color is injected into each vessel, and the vessels are attached at a specified position of the ink jet printer and then used.

There are ink jet printers in which, for example, a piezo system utilizing mechanical vibration; a bubble jet (registered trademark) system utilizing bubbles generated by heating; or the like is adopted. The ink jet recording method of the present invention can be employed according to any system.

The record-receiving material in the ink jet recording method of the present invention is not particularly limited, and any one is acceptable as long as it is a recordable substance which may include for example, a communication sheet such as a paper or film, a fiber or cloth (cellulose, nylon, wool, etc.), a leather, a substrate for color filters, etc.; however a communication sheet is preferred.

The aforementioned communication sheet is not particularly limited, and not only plain paper, but also paper subjected to a surface treatment can be used, specifically, paper, synthetic paper, films and the like having an ink receiving layer provided on the base material. The ink receiving layer is provided by, for example: a method in which a cation based polymer is impregnated in or coated on the aforementioned base material; a method in which inorganic fine particles that can absorb a coloring matter in an ink such as porous silica, alumina sol or special ceramics are coated on the surface of the aforementioned base material together with a hydrophilic polymer such as polyvinyl alcohol or polyvinylpyrrolidone. Such sheets provided with an ink receiving layer are generally referred to as ink jet exclusive paper, ink jet exclusive film, glossy paper, glossy film, and the like.

The plain paper means a paper which is not provided with an ink receiving layer in particular, and a variety of plain paper has been available in the market depending on their intended use. Examples of the commercially available plain paper include, for ink jet printing: Plain paper with high quality on both faces manufactured by Seiko Epson Corporation; Color plain paper manufactured by Canon, Inc.; Multipurpose Paper, All-in-one Printing Paper manufactured by Hewlett Packard Co.; and the like. In addition, paper for PPC not particularly limited for use in ink jet printing and the like are also included in plain paper.

The ink composition of the present invention is particularly superior in providing brilliance of the image recorded on the plain paper as described above, and of the communication sheets plain paper is preferred. However, since the ink composition of the present invention is also superior in fastness properties against light, ozone, humidity, water, friction and the like, it can be used on not only plain paper but also exclusive ink jet paper.

The colored body of the present invention means a substance colored with the ink composition of the present invention. The material entity of the colored body is not particularly limited as long as it is a substance colored, and for example, the aforementioned record-receiving materials, and the like may be included. The coloring method is not also particularly limited, and may include, for example, printing methods such as a dip dyeing method, a textile printing method and a screen printing, as well as ink jet recording methods, and the like, but the ink jet recording method is preferred.

The ink composition containing the coloring matter of the present invention exhibits extremely favorable storage stability, without solid deposition, physical property alteration, change in the hue and the like after storage for a long period of time. A printed matter obtained using the ink composition of the present invention as an ink for ink jet recording has an ideal hue as a magenta color hue without limitation of usable record-receiving material (for example, paper, film, etc.), and further photographic color images can be strictly reproduced on a paper.

The ink composition of the present invention has superior coloring properties and favorable brilliance, and thus is suited for use in printing, copying, marking, writing, drawing, stamping, or various types of recording (printing), and particularly in ink jet recording.

Furthermore, when the ink composition of the present invention is used in ink jet recording, a high-quality magenta-color recorded matter having favorable resistance against water, light, oxidizing gas such as ozone gas, humidity, friction and the like is obtained, and in particular, when recording is carried out on a record-receiving material including a porous white inorganic substance coated on its surface, such as an exclusive ink jet paper for photo image quality and a film, favorable ozone gas resistance, as well as superior storage stability of recorded image with photo image quality for a long time period can be achieved. Therefore, the ink composition is suited for ink jet recording having the characteristic that there is no limitation with respect to usable record-receiving material.

Additionally, when the ink composition of the present invention is used in ink jet recording, deposition of solids due to drying of the ink composition in the vicinity of the nozzle hardly occurs, and clogging of the injector (ink head) can be also avoided.

Accordingly, the coloring matter of the present invention and the ink composition of the present invention containing the same are extremely useful in various types of use as an ink, particularly use as an ink for ink jet recording.

### EXAMPLES

Hereinafter, the present invention is specifically described by way of Examples. In the specification, the expressions “part” and “%” are on the basis of the mass unless otherwise specifically stated.

Each operation of synthetic reaction, crystallization and the like was carried out under stirring unless otherwise stated particularly, and the reaction temperature disclosed is a measured value of the temperature in the reaction system. Also, when the intended compound was not obtained in a required amount by synthesis carried out once, the same reaction was repeatedly carried out until the required amount was attained.

It should be noted that each coloring matter contained in the ink composition of the present invention synthesized in Examples was subjected to measurement of λmax (wavelength of maximum absorption) in water, and thus obtained measurement value is shown.

### Example 1

### (Step 1)

Into 75.0 parts of orthodichlorobenzene were added 23.6 parts of a compound represented by the following formula (9) obtained by a well-known method, 0.75 parts of sodium carbonate and 36.0 parts of ethyl benzoylacetate serially, and the temperature of the mixture was elevated, followed by allowing to react at a temperature of 170 to 175° C. for 3 hrs. After completing the reaction, the reaction liquid was cooled, and thereto were added 150 parts of methanol at 30° C. After the mixture was stirred for 30 min, precipitated solid was separated by filtration. Thus obtained solid was washed with 200 parts of methanol, followed by washing with water. The solid was dried to obtain 28.8 parts of a compound represented by the following formula (10) as red solid.

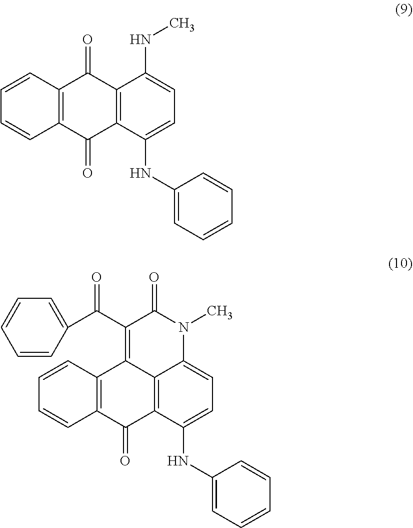

### (Step 2)

At room temperature, 18.2 parts of the compound represented by the above formula (10) were added to 151.5 parts of chlorosulfonic acid such that the temperature did not exceed 60° C. Thereafter, the temperature was elevated to 80° C., and the mixture was stirred for 4 hrs. The reaction liquid was cooled to 70° C., and 71.4 parts of thionyl chloride were added dropwise over 30 min while maintaining the temperature at 60 to 70° C. Thereafter, the reaction was allowed at 70° C. for 3 hrs. The reaction liquid left to cool down to room temperature was charged into 500 parts of ice water, and then 25.6 parts of aqueous hydrogen peroxide were further added thereto. During this step, ice was added appropriately, whereby the liquid temperature was maintained at no higher than 10° C. Thus precipitated reddish orange solid was separated by filtration to obtain 132.0 parts of a wet cake containing a compound represented by the following formula (11). It should be noted that the compound represented by the following formula (11) is a compound represented by the above formula (5) in which Q is a chlorine atom.

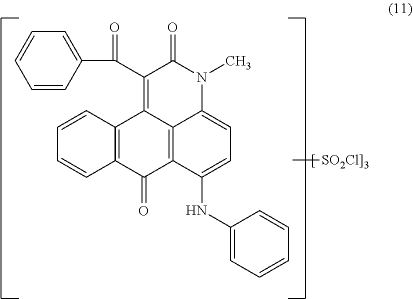

### (Step 3)

Into 120 parts of ice water were added 33.0 parts of a wet cake obtained in a similar manner to the above step 2, and the mixture was stirred for 10 min. Thereafter, 10.4 parts of metanilic acid were added thereto, and the reaction was permitted for 5 hrs and 30 min under a condition at 25 to 30° C., at a pH of 9.0 adjusted with an about 8% aqueous sodium hydroxide solution. To thus obtained reaction liquid was added 35% hydrochloric acid to adjust the pH to 3.0, and 30.0 parts of ammonium chloride were added thereto. Thus precipitated solid was separated by filtration, and washed with 100 parts of a 22% aqueous ammonium chloride solution to obtain a wet cake. The resultant wet cake was dissolved in 50 parts of water. Thereto were added 400 parts of isopropanol, and thus precipitated solid was separated by filtration. Thus obtained solid was dried to obtain 5.7 parts of an ammonium salt of a coloring matter represented by the following formula (12), which is represented by the above formula (4) in which h is 2.7; j is 0.3; and X_{d} is 3-sulfoanilino, as red solid. λmax: 520.5 nm.

HPLC Analysis Results:

| Number of substitution | |
|---|---|
| with “—SO₂Xd” | HPLC area ratio (%) |
| 1 | 4.2 |
| 2 | 34.4 |
| 3 | 61.4 |

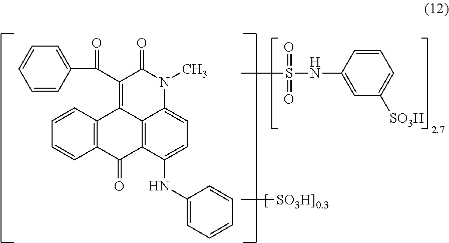

### Example 2

Into 1,440 parts of ice water were added 396.0 parts of a wet cake obtained in a similar manner to the step 2 of Example 1, and the mixture was stirred for 10 min. Thereafter, 124.7 parts of metanilic acid were added thereto, and the reaction was permitted for 4 hrs under a condition at 25 to 30° C., at a pH of 9.0 adjusted with a 25% aqueous sodium hydroxide solution. To thus obtained reaction liquid was added 35% hydrochloric acid to adjust the pH to 3.0, and 380.0 parts of sodium chloride were added thereto. Thus precipitated solid was separated by filtration, and washed with 300 parts of a 22% aqueous sodium chloride to obtain a wet cake. Thus resultant wet cake was added to water, and a solution was prepared while adjusting the pH of the liquid to 4.0 with a 25% aqueous sodium hydroxide solution. To this solution was further added water to adjust the total amount to 1300 parts. To the obtained solution were added 255 parts of sodium chloride, and thus precipitated solid was separated by filtration and washed with 200 parts of a 22% aqueous sodium chloride solution to obtain a wet cake. This operation was repeated three times to obtain a wet cake. Thus resultant wet cake was added to water, and a solution was prepared while adjusting the pH of the liquid to 4.0 with a 25% aqueous sodium hydroxide solution. To this solution was further added water to adjust the total amount to 800 parts. To the obtained solution were added 120 parts of ammonium chloride, and thus precipitated solid was separated by filtration and washed with 200 parts a 22% aqueous ammonium chloride solution to obtain a wet cake. Thus resultant wet cake was added to water, and a solution was prepared while adjusting the pH of the liquid to 4.0 with a 25% aqueous sodium hydroxide solution. To this solution was further added water to adjust the total amount to 800 parts. To the obtained solution were added 120 parts of sodium chloride, and thus precipitated solid was separated by filtration and washed with 200 parts of a 22% aqueous sodium chloride solution to obtain a wet cake containing 54.6 parts of a sodium salt of a coloring matter represented by the above formula (12), which is represented by the above formula (4) in which h is 2.7; j is 0.3; and X_{d} is 3-sulfoanilino.

Thus resultant wet cake was added to water to prepare an aqueous solution, and thereafter purified with a reverse osmosis membrane to obtain the ink composition of the present invention having a content of the coloring matter of 10% by mass. As a result of measurement of the content of chlorine ion and sulfuric acid ion in this ink composition, the content of these inorganic impurities in total was no greater than 300 ppm.

Note that the content of the coloring matter represented by the formula (12) in the total amount of the coloring matter contained in the ink composition was 98.2% in terms of the area ratio on HPLC. λmax: 519 nm.

HPLC Analysis Results:

| Number of substitution | |
|---|---|
| with “—SO₂Xd” | HPLC area ratio (%) |
| 1 | 4.0 |
| 2 | 18.4 |
| 3 | 77.6 |

### Example 3

Into 120 parts of ice water were added 33.0 parts of a wet cake obtained in a similar manner to the step 2 of Example 1, and the mixture was stirred for 10 min. Thereafter, 10.4 parts of sulfanilic acid were added thereto, and the reaction was permitted for 5 hrs under a condition at 25 to 30° C., at a pH of 9.0 adjusted with an about 8% aqueous sodium hydroxide solution. To this reaction liquid was added 35% hydrochloric acid to adjust the pH to 2.0. The solid precipitated by adding 30.0 parts of ammonium chloride was separated by filtration, and washed with 100 parts of a 22% aqueous ammonium chloride solution to obtain a wet cake. Thus resultant wet cake was dissolved again in 70 parts of water, and thereto was added a 25% aqueous sodium hydroxide solution to adjust the pH to 7.0. To the mixture were added 14.0 parts of ammonium chloride at 20° C. Thus precipitated solid was separated by filtration, and washed with a 24% aqueous ammonium chloride solution to obtain a wet cake. The resultant wet cake was dissolved in 20 parts of water. Thereto were added 300 parts of isopropanol, and thus precipitated solid was separated by filtration, followed by drying to obtain 4.45 parts of an ammonium salt of a coloring matter represented by the following formula (13), which is represented by the above formula (4) in which h is 2.1; j is 0.9; and X_{d} is 4-sulfoanilino, as red solid. λmax: 522 nm.

HPLC Analysis Results:

| Number of substitution | |
|---|---|
| with “—SO₂Xd” | HPLC area ratio (%) |
| 1 | 16.6 |
| 2 | 54.9 |
| 3 | 28.5 |

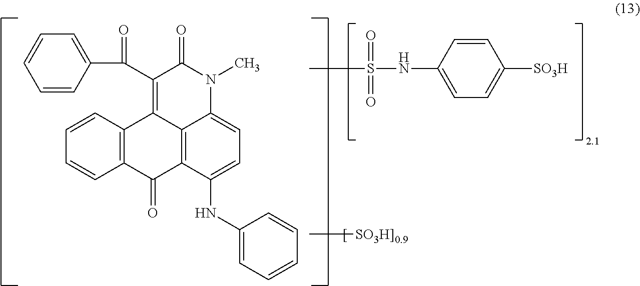

### Example 4

To 100 part of water were added 6.1 parts of o-anisidine-5-sulfonic acid, and the mixture was stirred. To this liquid was added dropwise over 1 hour a liquid prepared by adding 33.0 parts of a wet cake which had been obtained in a similar manner to the step 2 of Example 1 into 120 parts of ice water followed by stirring for 10 min. During this procedure, the reaction liquid was maintained at 25 to 30° C., and a pH of 6.5 to 7.0 with an about 8% aqueous sodium hydroxide solution. This reaction liquid was allowed to react for 3 hrs at 25 to 30° C., while maintaining the pH at 6.5 to 7.0. To thus obtained reaction liquid was added 35% hydrochloric acid to adjust the pH to 3.0, and 38.0 parts of ammonium chloride were added thereto. Thus precipitated solid was separated by filtration, and washed with 100 parts of a 22% aqueous ammonium chloride solution to obtain a wet cake. Thus resultant wet cake was again dissolved in 40 parts of water, and the pH was adjusted to 6.6 using a 25% aqueous sodium hydroxide solution. To the mixture were added 4.0 parts of ammonium chloride. Thus precipitated solid was separated by filtration, and washed with 100 parts of a 24% aqueous ammonium chloride solution to obtain a wet cake. Thus resultant wet cake was dissolved in 20 parts of water. Thereto were added 400 parts of isopropanol, and thus precipitated solid was separated by filtration. Thus obtained solid was dried to obtain 3.1 parts of an ammonium salt of a coloring matter represented by the following formula (14), which is represented by the above formula (4) in which h is 2.7; j is 0.3; and X_{d} is 2-methoxy-5-sulfoanilino, as red solid. λmax: 516 nm.

HPLC Analysis Results:

| Number of substitution | |
|---|---|
| with “—SO₂Xd” | HPLC area ratio (%) |
| 1 | 4.0 |
| 2 | 22.0 |
| 3 | 77.6 |

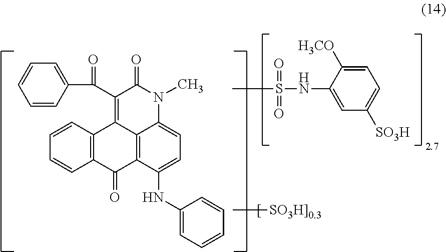

### Example 5

Into 120 parts of ice water were added 33.0 parts of a wet cake obtained in a similar manner to the step 2 of Example 1, and the mixture was stirred for 10 min. Thereafter, 14.0 parts of Broenner's acid were added thereto, and the reaction was permitted for 2 hrs under a condition at 25 to 30° C., at a pH of 8.0 adjusted with an about 8% aqueous sodium hydroxide solution. To this reaction liquid was added 35% hydrochloric acid to adjust the pH to 8.0. The solid precipitated by adding 17.0 parts of ammonium chloride to the obtained liquid was separated by filtration, and washed with 100 parts of a 15% aqueous ammonium chloride solution to obtain a wet cake. Thus resultant wet cake was again dissolved in 200 parts of water, and thereto was added a 25% aqueous sodium hydroxide solution to adjust the pH to 9.0. The solid precipitated by adding 20.0 parts of ammonium chloride at 20° C. was separated by filtration to obtain a wet cake. A wet cake obtained by further repeating this operation three times was suspended in 50 parts of water, and thus precipitated solid was separated by filtration to obtain a wet cake. Thus resultant wet cake was dissolved in 50 parts of water. Thereto were added 400 parts of isopropanol, and thus precipitated solid was separated by filtration, followed by drying to obtain 7.2 parts of an ammonium salt of a coloring matter represented by the following formula (15), which is represented by the above formula (4) in which h is 2.8; j is 0.2; and X_{d} is 6-sulfo-2-naphthylamino, as red solid. λmax: 533.5 nm.

HPLC Analysis Results:

| Number of substitution | |
|---|---|
| with “—SO₂Xd” | HPLC area ratio (%) |
| 1 | 1.9 |
| 2 | 16.9 |
| 3 | 81.2 |

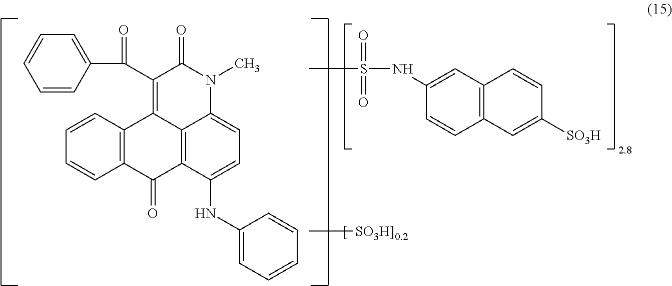

### Example 6

Into 120 parts of ice water were added 33.0 parts of a wet cake obtained in a similar manner to the step 2 of Example 1, and the mixture was stirred for 10 min. Thereafter, 14.0 parts of 1,6-Cleve's acid were added thereto, and the reaction was permitted for 3 hrs under a condition at 25 to 30° C., at a pH of 8.0 adjusted with an about 8% aqueous sodium hydroxide solution. To thus obtained reaction liquid was added 35% hydrochloric acid to adjust the pH to 2.0, and unreacted 1,6-Cleve's acid precipitated was filtered off. To the obtained filtrate was added a 25% aqueous sodium hydroxide solution to adjust the pH to 3.0, and 19.0 parts of ammonium chloride were added thereto. Thus precipitated solid was separated by filtration, and washed with 100 parts of a 24% aqueous ammonium chloride solution to obtain a wet cake. Thus resultant wet cake was dissolved in 100 parts of water, and thereto was added 28% aqueous ammonia to adjust the pH to 9.0. The solid precipitated by adding 10.0 parts of ammonium chloride was separated by filtration to obtain a wet cake. A wet cake obtained by repeating this operation four times was suspended in 50 parts of water, and thus precipitated solid was separated by filtration to obtain a wet cake. The resultant wet cake was dissolved in 50 parts of water. Thereto were added 400 parts of isopropanol, and thus precipitated solid was separated by filtration, followed by drying to obtain 7.2 parts of an ammonium salt of a coloring matter represented by the following formula (16), which is represented by the above formula (4) in which h is 2.8; j is 0.2; and X_{d} is 6-sulfo-1-naphthylamino, as red solid. λmax: 527.5 nm.

HPLC Analysis Results:

| Number of substitution | |
|---|---|
| with “—SO₂Xd” | HPLC area ratio (%) |
| 1 | 0 |
| 2 | 16.0 |
| 3 | 84.0 |

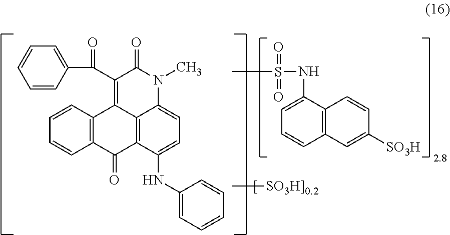

### Example 7

Into 120 parts of ice water were added 33.0 parts of a wet cake obtained in a similar manner to the step 2 of Example 1, and the mixture was stirred for 10 min. Thereafter, 19.8 parts of naphthionic acid were added thereto, and the reaction was permitted for 17 hrs under a condition at 25 to 30° C., at a pH of 9.0 adjusted with an about 8% aqueous sodium hydroxide solution. To thus obtained reaction liquid was added 35% hydrochloric acid to adjust the pH to 6.0. The solid precipitated by adding 13.0 parts of ammonium chloride was separated by filtration, and washed with 100 parts of a 24% aqueous ammonium chloride solution to obtain a wet cake. Thus resultant wet cake was dissolved in 100 parts of water, and a 25% aqueous sodium hydroxide solution was added thereto to adjust the pH to 6.5. The solid precipitated by adding 10.0 parts of ammonium chloride was separated by filtration to obtain a wet cake. The resultant wet cake was dissolved in 100 parts of water, and the pH was adjusted to 8.0 using 28% aqueous ammonia. The solid precipitated by adding 10.0 parts of ammonium chloride was separated by filtration to obtain a wet cake. A wet cake obtained by repeating this operation twice was suspended in 50 parts of water, and thus precipitated solid was separated by filtration to obtain a wet cake. The resultant wet cake was dissolved in 20 parts of water. Thereto were added 300 parts of isopropanol, and thus precipitated solid was separated by filtration, followed by drying to obtain 3.5 parts of an ammonium salt of a coloring matter represented by the following formula (17), which is represented by the above formula (4) in which h is 2.6; j is 0.4; and X_{d} is 4-sulfo-1-naphthylamino, as red solid. λmax: 519.5 nm.

HPLC Analysis Results:

| Number of substitution | |
|---|---|
| with “—SO₂Xd” | HPLC area ratio (%) |
| 1 | 5.6 |
| 2 | 26.8 |
| 3 | 67.6 |

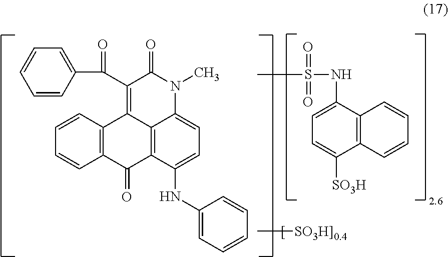

### Example 8

### (Step 1)

Into 120 parts of ice water were added 33.0 parts of a wet cake obtained in a similar manner to the step 2 of Example 1, and the mixture was stirred for 10 min. Thereafter, 6.5 parts of p-toluidine were added thereto, and the reaction was permitted for 3 hrs under a condition at 25 to 30° C., at a pH of 9.0 adjusted with an about 8% aqueous sodium hydroxide solution. The solid precipitated in thus obtained reaction liquid was separated by filtration, washed with water and dried to obtain 8.6 parts of a compound represented by the following formula (18), as red solid.

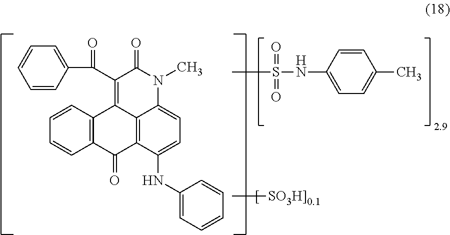

### (Step 2)

The temperature of 20.2 parts of 96% sulfuric acid was adjusted to 5 to 10° C. by ice cooling, and 14.8 parts of 31.3% fuming sulfuric acid were added dropwise over 30 min while maintaining the same temperature. To thus obtained liquid were added 4.0 parts of a compound represented by the formula (18) obtained in the above step 1, and the reaction was permitted for 24 hrs while the temperature was gradually elevated to room temperature. Thus obtained reaction liquid was added dropwise over 1 hour to ice water including 20 parts of water and 50 parts of ice. To thus obtained liquid was added a 25% aqueous sodium hydroxide solution to adjust the pH to 7.0, and 800 parts of isopropanol were added thereto. Thus precipitated solid was separated by filtration. Thus obtained solid was added to 200 parts of 10% hydrous ethanol and the mixture was stirred. Thus precipitated solid was separated by filtration. This operation was repeated three times to obtain solid. Thus obtained solid was dissolved in 150 parts of water, and thereto was appropriately added acetone (typically, in an amount almost the same as the amount of water). Accordingly, inorganic salts were precipitated as insoluble solid, which was filtered off. Thus obtained filtrate was evaporated, and the precipitated solid was suspended in isopropanol. Thereafter, separation by filtration, and drying gave 2.08 parts of a sodium salt of the coloring matter of the present invention represented by the following formula (19), as red solid. For reference, the content of the coloring matter represented by the formula (19) in total mass of the coloring matter determined by the HPLC analysis was 93.0% in terms of the area ratio on HPLC. λmax: 549.5 nm.

HPLC Analysis Results:

| Number of substitution | |
|---|---|
| with “—SO₂Xd” | HPLC area ratio (%) |
| 1 | 100.0 |
| 2 | 0 |
| 3 | 0 |

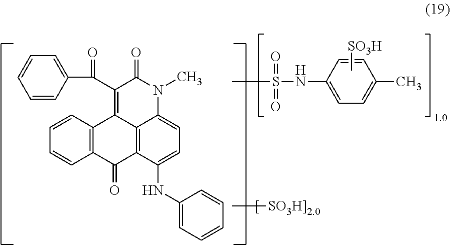

### Example 9

### (Step 1)

Into 120 parts of ice water were added 33.0 parts of a wet cake obtained in a similar manner to the step 2 of Example 1, and the mixture was stirred for 10 min. Thereafter, 7.5 parts of o-anisidine were added thereto, and the reaction was permitted for 22 hrs under a condition at 25 to 30° C., at a pH of 9.0 adjusted with an about 8% aqueous sodium hydroxide solution. The solid precipitated in thus obtained reaction liquid was separated by filtration, washed with water and dried to obtain 10.0 parts of a compound represented by the following formula (20), as red solid.

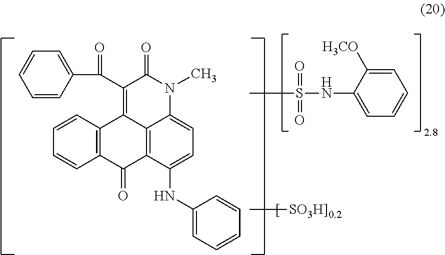

### (Step 2)

The temperature of 20.2 parts of 96% sulfuric acid was adjusted to 5 to 10° C. by ice cooling, and 14.8 parts of 31.3% fuming sulfuric acid were added dropwise over 30 min while maintaining the same temperature. To thus obtained liquid were added 3.0 parts of a compound represented by the formula (20) obtained in the above step 1, and the reaction was permitted for 21 hrs while the temperature was gradually elevated to room temperature. Thus obtained reaction liquid was added dropwise over 1 hour to ice water including 20 parts of water and 50 parts of ice, and the pH was adjusted to 7.0 by adding 28% aqueous ammonia thereto. To thus obtained liquid were added 800 parts of isopropanol, and thus precipitated solid was separated by filtration. Thus obtained solid was added to 200 parts of 5% hydrous ethanol and the mixture was stirred. Thus precipitated solid was separated by filtration. This operation was repeated three times to obtain solid. Thus obtained solid was dissolved in 150 parts of water, and thereto was appropriately added acetone (typically, in an amount almost the same as the amount of water). Accordingly, inorganic salts were precipitated as insoluble solid, which was filtered off. Thus obtained filtrate was evaporated, and the precipitated solid was suspended in isopropanol. Thereafter, separation by filtration, and drying gave 1.3 parts of a sodium salt of the coloring matter of the present invention represented by the following formula (21), as red solid. For reference, the content of the coloring matter represented by the formula (21) in total mass of the coloring matter determined by the HPLC analysis was 85.1% in terms of the area ratio on HPLC. λmax: 530.5 nm.

HPLC Analysis Results:

| Number of substitution | |
|---|---|
| with “—SO₂Xd” | HPLC area ratio (%) |
| 1 | 98.3 |
| 2 | 0 |
| 3 | 1.7 |

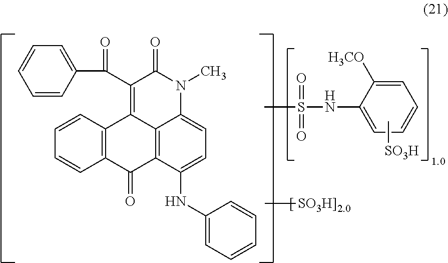

### Example 10

### (Step 1)

Into 120 parts of ice water were added 33.0 parts of a wet cake obtained in a similar manner to the step 2 of Example 1, and the mixture was stirred for 10 min. Thereafter, 7.5 parts of p-anisidine were added thereto, and the reaction was permitted for 4 hrs and 30 min under a condition at 25 to 30° C., at a pH of 9.0 adjusted with an about 8% aqueous sodium hydroxide solution. The solid precipitated in thus obtained reaction liquid was separated by filtration, washed with water and dried to obtain 10.0 parts of a compound represented by the following formula (22), as red solid.

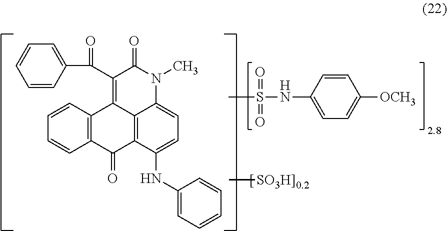

### (Step 2)

The temperature of 28.8 parts of 96% sulfuric acid was adjusted to 5 to 10° C. by ice cooling, and 21.2 parts of 31.3% fuming sulfuric acid were added dropwise over 30 min while maintaining the same temperature. To thus obtained liquid were added 5.0 parts of a compound represented by the formula (22) obtained in the above step 1, and the reaction was permitted for 2 hrs and 20 min while the temperature was gradually elevated to room temperature. Thus obtained reaction liquid was added dropwise over 1 hour to ice water including 20 parts of water and 50 parts of ice. Thus precipitated solid was separated by filtration and washed with 100 parts of a 24% aqueous ammonium chloride solution to obtain a wet cake. Thus obtained wet cake was added to water, and the pH of the liquid was adjusted to 9.0 with a 25% aqueous sodium hydroxide solution to prepare a solution. Thereto was further added water to adjust the total amount of the solution to 100 parts. To the obtained solution were added 10 parts of ammonium chloride, and thus precipitated solid was separated by filtration and washed with 100 parts of a 15% aqueous ammonium chloride solution to obtain a wet cake. This wet cake was added to water, and the pH of the liquid was adjusted to 9.0 with 28% aqueous ammonia to prepare a solution. Thereto was further added water to adjust the total amount of the liquid to 70 parts. To the obtained solution were added 14 parts of ammonium chloride, and thus precipitated solid was separated by filtration and washed with 100 parts of a 24% aqueous ammonium chloride solution to obtain a wet cake. After the resultant wet cake was dissolved in 20 parts of water, 400 parts of isopropanol were added thereto. The precipitated solid was separated by filtration and dried to obtain 3.2 parts of an ammonium salt of the coloring matter of the present invention represented by the following formula (23), as red solid. For reference, the content of the coloring matter represented by the formula (23) in total mass of the coloring matter determined by the HPLC analysis was 84.3% in terms of the area ratio on HPLC. λmax: 533.0 nm.

HPLC Analysis Results:

| Number of substitution | |
|---|---|
| with “—SO₂Xd” | HPLC area ratio (%) |
| 1 | 1.8 |
| 2 | 13.1 |
| 3 | 85.1 |

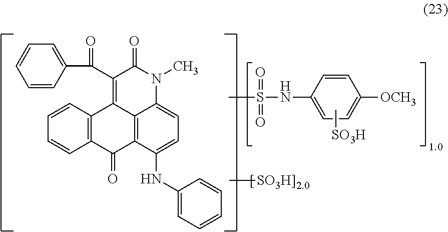

### Example 11

Into 120 parts of ice water were added 33.0 parts of a wet cake obtained in a similar manner to the step 2 of Example 1, and the mixture was stirred for 10 min. Thereafter, 19.8 parts of C acid were added thereto, and the reaction was permitted for 16 hrs under a condition at 25 to 30° C., at a pH of 8.0 adjusted with an about 8% aqueous sodium hydroxide solution. The pH of the obtained reaction liquid was adjusted to 0.5 by adding 35% hydrochloric acid, and the precipitated solid was filtered off. To the filtrate was added a 25% aqueous sodium hydroxide solution to adjust the pH to 7.2, and water was further added thereto to give the total amount of the liquid to 100 parts. To the obtained liquid was appropriately added acetone (typically, in an amount almost the same as the amount of water), and the generated tar was separated from the supernatant liquid by decantation. To thus obtained tar were added 30 parts of water, and the pH of the liquid was adjusted to 9.0 with 28% aqueous ammonia to prepare a solution. To this solution were added 400 parts of isopropanol, and thus precipitated solid was separated by filtration. This operation was repeated five times, and the obtained solid was dried to obtain 17.4 parts of an ammonium salt of a coloring matter represented by the following formula (24), which is represented by the above formula (4) in which X_{d} is 4,8-disulfo-2-naphthylamino, as red solid. λmax: 529.5 nm.

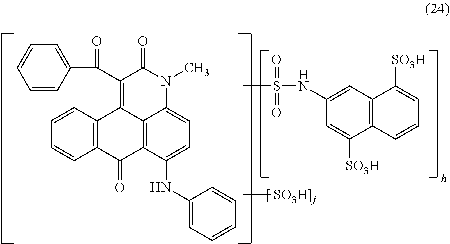

### Example 12 to Example 22

### (A) Preparation of Ink

Using the ammonium salt of the coloring matter represented by the formula (12) obtained in Example 1, the composition shown in Table 3 below was mixed to prepare the ink composition of the present invention, which was filtered through a 0.45 μm membrane filter. Accordingly, an ink for evaluation was provided. In Table 3, “water” employed was ion exchanged water including water used for dilution in aqueous ammonia. Water, and a 2.8% aqueous ammonia solution were appropriately added such that the pH of the ink composition became 8 to 10, and that the total amount became 100 parts. This preparation of the ink is designated as Example 12. Furthermore, inks for test were prepared in a similar manner to Example 12 except that the coloring matters obtained in Examples 2 to 11 were used, respectively, in place of the coloring matter obtained in Example 1. Preparations of the inks for test are designated as Examples 13 to 22, respectively. The coloring matter obtained in each Example means the coloring matter of the present invention obtained in the final step of each Example. For example, the coloring matter obtained in Example 1 is the coloring matter of the present invention represented by the formula (12) obtained in the step 3 of Example 1.

In Table 3, “surfactant” employed was trade name Surfynol® 104PG50 manufactured by Nissin Chemical Co., Ltd.

TABLE 3
Blend of ink composition

| | |
|---|---|
| Coloring matter obtained in Example 1 | 3.5 parts |
| glycerin | 5.0 parts |
| urea | 5.0 parts |
| N-methyl-2-pyrrolidone | 4.0 parts |
| isopropyl alcohol | 3.0 parts |
| butylcarbitol | 2.0 parts |
| surfactant | 0.1 parts |
| water + 2.8% aqueous ammonia | 77.4 parts |
| total | 100.0 parts |

### Comparative Example 1

An ink for comparison was prepared in a similar manner to Examples 12 to 22 except that a dried wet cake containing a compound represented by the following formula (25) obtained by following Example 1 (1) to (3) of Patent Document 12 was used as a coloring matter in place of the coloring matter obtained in Example 1. This preparation is designated as Comparative Example 1.

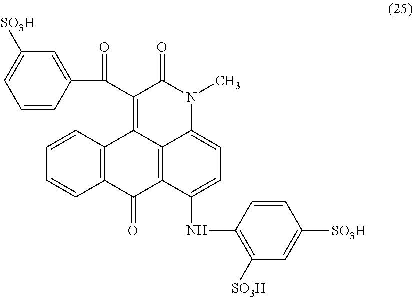

### (B) Ink Jet Recording

Ink-jet recording was carried out using an ink jet printer (manufactured by Canon, Inc., Pixus iP4100) on glossy papers having an ink image receiving layer containing a porous white inorganic substance. Upon the ink-jet recording, an image pattern was provided such that the tone with several levels of print density can be yielded, and a recorded matter was produced for use as a test piece to perform an evaluation test.

The employed glossy papers were as follows.
Glossy paper 1: manufactured by Canon, Inc., trade name Photo Paper gloss Pro [Platinum Grade]
Glossy paper 2: manufactured by Canon, Inc., trade name Photo Paper Gloss Gold
Glossy paper 3: manufactured by Epson, trade name Photo Paper CRISPIA (Super Glossy)
Glossy paper 4: manufactured by HP Co., trade name Advanced Photo Paper

### (C) Ozone Gas Resistance Test of Recorded Image

The test piece was placed on an ozone weather meter (manufactured by Suga Test Instruments Co., Ltd.), and left to stand in an environment involving an ozone concentration of 10 ppm, a humidity of 60% RH, at a temperature of 24° C. for 24 hrs. On gradation portions where the reflected density D value was most approximate to 1.0 in the test piece before the test, D values before and after the test were measured using a colorimetric system (GRETAG® SPM50: manufactured by GRETAG) under a condition involving: a light source of D65; a viewing angle of 2 degree; and a concentration standard of DIN, and the residual ratio of the coloring matter was determined according to the following formula. The results are shown in Table 4 below.

Residual ratio of the coloring matter=(Reflected density after test/Reflected density before test)×100 (%)

TABLE 4

| Results of ozone | glossy | glossy | glossy | glossy |
|---|---|---|---|---|
| gas resistance test | paper 1 | paper 2 | paper 3 | paper 4 |
| Example 12 | 95 | 94 | 95 | 95 |
| Example 13 | 95 | 94 | 95 | 94 |
| Example 14 | 92 | 91 | 93 | 93 |
| Example 15 | 94 | 93 | 95 | 94 |
| Example 16 | 97 | 93 | 95 | 94 |
| Example 17 | 92 | 90 | 92 | 92 |
| Example 18 | 93 | 91 | 93 | 94 |
| Example 19 | 91 | 89 | 93 | 94 |
| Example 20 | 93 | 91 | 91 | 93 |
| Example 21 | 89 | 87 | 92 | 90 |
| Example 22 | 91 | 91 | 93 | 93 |
| Comparative | 81 | 81 | 88 | 85 |
| Example 1 | | | | |

As is clear from Table 4, results of evaluation of each of Examples 12 to 22 were superior as compared with Comparative Example 1 on all glossy papers 1 to 4, and thus it was revealed that images recorded with the ink composition containing the coloring matter of the present invention were excellent in ozone gas resistance.

### INDUSTRIAL APPLICABILITY

From the foregoing results, the magenta coloring matter of the present invention is suited for preparing a magenta ink for ink jet recording, and is superior in a variety of fastness, particularly ozone gas resistance on glossy papers. Therefore, the magenta coloring matter of the present invention, and the ink composition of the present invention containing the same are very useful for various types of use in recording, particularly for use in ink jet recording.

1. An ink composition comprising at least one coloring matter represented by the following formula (1) or a salt thereof: 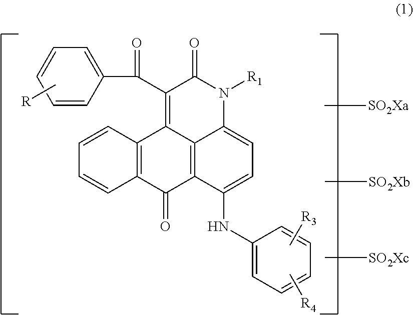
wherein,
Xₐ to X_{c} each independently represent represents an unsubstituted sulfoanilino group; a sulfoanilino group substituted with a group selected from the group consisting of a C1-C12 alkyl group, a C1-C6 alkoxy group and a hydroxy group; an unsubstituted sulfonaphthylamino group; a sulfonaphthylamino group substituted with a C1-C4 alkyl group or a hydroxy group; or a hydroxy group;
at least one of Xₐ to X_{c} is a group other than a hydroxy group;
R represents a hydrogen atom, a carboxy group, a C1-C8 alkoxy group, a C1-C6 alkylthio group, a carbamoyl group, a cyano group, a C1-C8 alkyl group, an anilino group, a phenoxy group, an amino group, a hydroxy group, or a mercapto group;
R₁ represents a hydrogen atom, a C1-C8 alkyl group, a hydroxy C1-C4 alkyl group, a phenyl group, a mono(C1-C4 alkyl)amino C1-C4 alkyl group, a di(C1-C4 alkyl)amino C1-C4 alkyl group, or a cyano C1-C4 alkyl group; and
R₃ and R₄ each independently represent represents a hydrogen atom or a C1-C8 alkyl group.

2. The ink composition according to claim 1, wherein the total content of the coloring matter contained in the ink composition is 0.5 to 20% by mass relative to the total mass of the ink composition.

3. The ink composition according to claim 1, further comprising a water-soluble organic solvent.

4. The ink composition according to claim 1, wherein the ink composition is used in ink jet recording.

5. The ink composition according to claim 1, wherein the content of inorganic impurities in the total mass of the coloring matter contained in the ink composition is no greater than 1% by mass relative to the total mass of the coloring matter.

6. An ink jet recording method comprising discharging ink droplets in response to recording signals using the ink composition according to claim 1 as an ink to allow the droplets to adhere onto a record-receiving material thereby executing recording.

7. The ink jet recording method according to claim 6, wherein the record-receiving material is a communication sheet.

8. The ink jet recording method according to claim 7, wherein the communication sheet is a plain paper or a sheet having an ink receiving layer containing a porous white inorganic substance.

9. A colored body which was is colored with the ink composition according to claim 1.

10. A colored body which is colored by the ink jet recording method according to claim 6.

11. An ink jet printer comprising a vessel containing the ink composition according to claim 1.

12. The ink composition according to claim 1, wherein the coloring matter represented by the above formula (1) or a salt thereof is a coloring matter represented by the following formula (2) or a salt thereof: 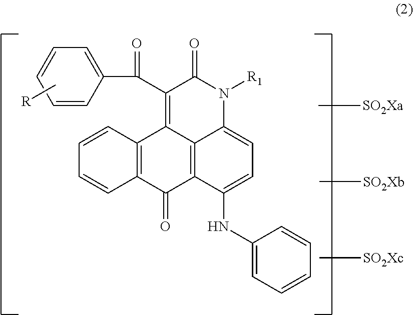
wherein, Xₐ to X_{c}, R, and R₁ are as defined in the formula (1).

13. The ink composition according to claim 1, wherein the coloring matter represented by the above formula (1) or a salt thereof is a coloring matter represented by the following formula (3) or a salt thereof: 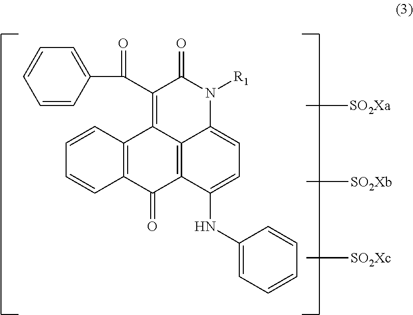
wherein, Xₐ to X_{c}, and R₁ are as defined in the formula (1).

14. The ink composition according to claim 1, wherein the coloring matter represented by the above formula (1) or a salt thereof is a coloring matter represented by the following formula (4) or a salt thereof: 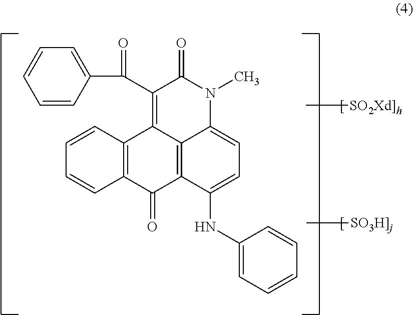
wherein,
X_{d} represents an unsubstituted sulfoanilino group; a sulfoanilino group substituted with a group selected from the group consisting of a C1-C12 alkyl group, a C1-C6 alkoxy group and a hydroxy group; an unsubstituted sulfonaphthylamino group; or a sulfonaphthylamino group substituted with a C1-C4 alkyl group or a hydroxy group;
h and j are both an average value; h is from 0.8 to 3.0; j is from 0 to 2.2; and the sum of h and j is 3.0.

15. The ink composition according to claim 1, wherein the coloring matter represented by the above formula (1) or a salt thereof is obtained by synthesis method a) or synthesis method b);
synthesis method a):
a method comprising allowing a compound represented by the following formula (5) to react with at least one amine selected from the group consisting of an unsubstituted sulfoaniline; a sulfoaniline substituted with a group selected from the group consisting of a C1-C12 alkyl group, a C1-C6 alkoxy group and a hydroxy group; an unsubstituted sulfonaphthylamine; and a sulfonaphthylamine substituted with a C1-C4 alkyl group or a hydroxy group, and
synthesis method b):
a method comprising allowing a compound represented by the following formula (5) to react with at least one amine selected from the group consisting of an unsubstituted aniline; an aniline substituted with a group selected from the group consisting of a C1-C12 alkyl group, a C1-C6 alkoxy group and a hydroxy group; an unsubstituted naphthylamine; and a naphthylamine substituted with a C1-C4 alkyl group or a hydroxy group, and thereafter subjecting the obtained compound to sulfonation, 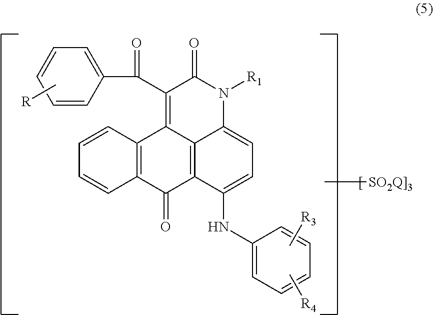
wherein, Q represents a halogen atom; and R, R₁, R₃ and R₄ are as defined in the formula (1).

16. A magenta coloring matter consisting of at least one coloring matter represented by the following formula (1), or a salt thereof: 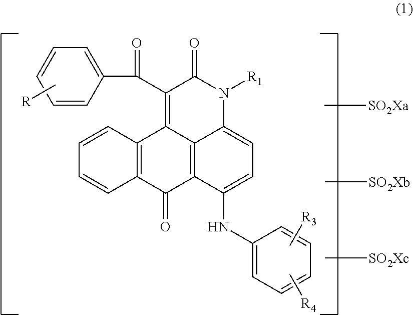
wherein,
Xₐ to X_{c} each independently represent represents an unsubstituted sulfoanilino group; a sulfoanilino group substituted with a group selected from the group consisting of a C1-C12 alkyl group, a C1-C6 alkoxy group and a hydroxy group; an unsubstituted sulfonaphthylamino group; a sulfonaphthylamino group substituted with a C1-C4 alkyl group or a hydroxy group; or a hydroxy group;
at least one of Xₐ to X_{c} is a group other than a hydroxy group;
R represents a hydrogen atom, a carboxy group, a C1-C8 alkoxy group, a C1-C6 alkylthio group, a carbamoyl group, a cyano group, a C1-C8 alkyl group, an anilino group, a phenoxy group, an amino group, a hydroxy group, or a mercapto group;
R₁ represents a hydrogen atom, a C1-C8 alkyl group, a hydroxy C1-C4 alkyl group, a phenyl group, a mono(C1-C4 alkyl)amino C1-C4 alkyl group, a di(C1-C4 alkyl)amino C1-C4 alkyl group, or a cyano C1-C4 alkyl group; and
R₃ and R₄ each independently represents a hydrogen atom or a C1-C8 alkyl group.

17. The magenta coloring matter or a salt thereof according to claim 16, wherein the coloring matter represented by the above formula (1) is a coloring matter represented by the following formula (2): 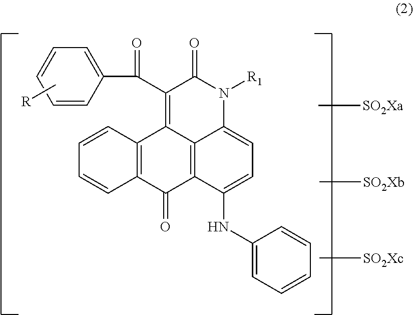
wherein, Xₐ to X_{c}, R, and R₁ are as defined in the formula (1).

18. The magenta coloring matter or a salt thereof according to claim 16, wherein the coloring matter represented by the above formula (1) is a coloring matter represented by the following formula (3): 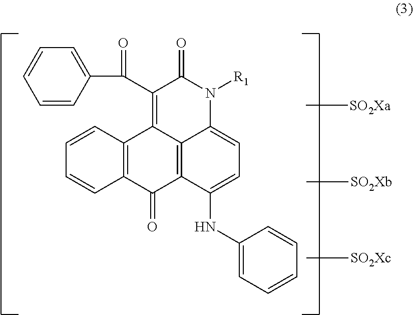
wherein, Xₐ to X_{c}, and R₁ are as defined in the formula (1).

19. The magenta coloring matter or a salt thereof according to claim 16, wherein the coloring matter represented by the above formula (1) is a coloring matter represented by the following formula (4): 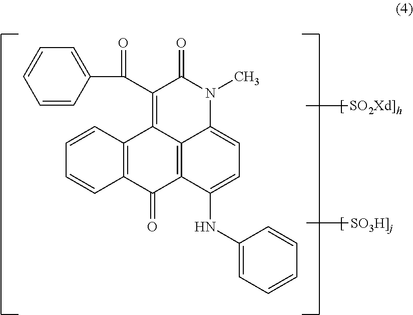
wherein,
X_{d} represents an unsubstituted sulfoanilino group; a sulfoanilino group substituted with a group selected from the group consisting of a C1-C12 alkyl group, a C1-C6 alkoxy group and a hydroxy group; an unsubstituted sulfonaphthylamino group; or a sulfonaphthylamino group substituted with a C1-C4 alkyl group or a hydroxy group;
h and j are both an average value; h is from 0.8 to 3.0; j is from 0 to 2.2; and the sum of h and j is 3.0.

20. The magenta coloring matter or a salt thereof according to claim 16, wherein the coloring matter represented by the above formula (1) is a coloring matter obtained by synthesis method a) or synthesis method b);
synthesis method a):
a method comprising allowing a compound represented by the following formula (5) to react with at least one amine selected from the group consisting of an unsubstituted sulfoaniline; a sulfoaniline substituted with a group selected from the group consisting of a C1-C12 alkyl group, a C1-C6 alkoxy group and a hydroxy group; an unsubstituted sulfonaphthylamine; and a sulfonaphthylamine substituted with a C1-C4 alkyl group or a hydroxy group
synthesis method b):
a method comprising allowing a compound represented by the following formula (5) to react with at least one amine selected from the group consisting of an unsubstituted aniline; an aniline substituted with a group selected from the group consisting of a C1-C12 alkyl group, a C1-C6 alkoxy group and a hydroxy group; an unsubstituted naphthylamine; and a naphthylamine substituted with a C1-C4 alkyl group or a hydroxy group, and thereafter subjecting the obtained compound to sulfonation, 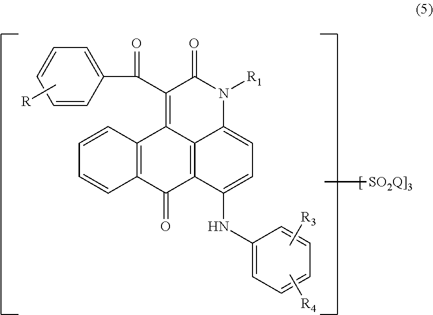
wherein, Q represents a halogen atom; and R, R₁, R₃ and R₄ are as defined in the formula (1).
